(19) United States
(12) Patent Application Publication
(10) Pub. No.: US 2025/0072417 A1
(43) Pub. Date: Mar. 6, 2025

(54) SINGLE PHASE WATER-BASED INSECTICIDE

(71) Applicant: S. C. JOHNSON & SON, INC., Racine, WI (US)

(72) Inventors: Cassidy N. Goff, Wauwatosa, WI (US); Kevin J. Moe, Mount Pleasant, WI (US); Kent M. Palkki, Racine, WI (US); Gary Hurtienne, Racine, WI (US)

(21) Appl. No.: 18/817,017

(22) Filed: Aug. 27, 2024

Related U.S. Application Data
(60) Provisional application No. 63/536,276, filed on Sep. 1, 2023.

(51) Int. Cl. A01N 25/06; A01N 53/00; A01N 65/12; A01P 7/04

(52) U.S. Cl. CPC A01N 25/06; A01N 53/00; A01N 65/12; A01P 7/04

(57) ABSTRACT

A composition that includes an active component, at least one non-aqueous solvent, at least one surfactant, and water. The composition may further include a synergist. The composition may further contain a propellant. A method of killing pests is also disclosed that includes applying to a surface in need thereof the composition.

### CROSS REFERENCE TO RELATED APPLICATIONS

This application claims priority to U.S. Application No. 63/536,276, filed on Sep. 1, 2023. The entire contents of the aforementioned application are incorporated by reference herein.

### REFERENCE REGARDING FEDERALLY SPONSORED RESEARCH OR DEVELOPMENT

Not applicable.

### SEQUENCE LISTING

Not applicable.

### BACKGROUND

### Technology Field

The present disclosure relates to an insecticidal composition and, more particularly, to a single phase, water-based insecticide composition including synthetic pyrethroids, or a natural pyrethrin.

### Description of the Background

Insecticidal compositions have been used over the years to prevent insects from attacking humans, animals, crops, and being a nuisance. A subset of insecticides includes flying insecticide killing (FIK), crawling insect killing (CIK), and multiple-insect killing (MIK) formulations. Currently, most water-based aerosols in the FIK/CIK/MIK category are not stable emulsions and require up to 10 seconds of shaking before use. This is a particular challenge as solvent-based aerosols do not require shaking so some consumers do not intuitively shake the product before spraying, thus resulting in decreased efficacy and decreased length of functional spray life.

Traditional aerosol insecticides contain volatile organic compounds (VOCs), which may be present in the formulation as active agents, solvents, fragrances, or propellants. In addition to consumers desiring sustainable insecticide compositions which contain limited VOCs, there is also pressure from regulatory bodies to reduce VOC levels in certain consumer products. Further, consumers prefer insecticide compositions that are in both trigger and aerosol form. Lastly, consumers prefer insecticide compositions which are clear and/or colorless so it may be placed in a clear bottle to convey more safety to the consumer, or for when it is sprayed on a surface it doesn't give a messy appearance.

Accordingly, consumers have expressed a preference for easy-to-use, sustainable insecticides with similar insecticide efficacy as traditional insecticides. Thus, the market has identified a need for an insecticide composition which is a single phase, water-based formulation, which does not require shaking before application, and is preferably clear and/or colorless.

### SUMMARY

In one aspect, a pest control composition is provided. In this embodiment, the pest control composition includes an active insecticide ingredient, at least one non-aqueous solvent, at least one surfactant, and water. The pest control composition may also include a synergist, in certain aspects.

In various aspects, the active component can be present in a range of about 0.05 wt. % to about 1 wt. % of pyrethrum or pyrethroids, the synergist, if used, can be present in a range of about 0.45 wt. % to about 5 wt. % of piperonyl butoxide or other synergist, the at least one non-aqueous solvent can be present in a range of about 2 wt. % to about 12 wt. %, the at least one surfactant can be present in a range of about 0.7 wt. % to about 8 wt. %, and the water can be present in a range of about 74 wt. % to about 91 wt. %. In one or more aspects, a weight ratio of piperonyl butoxide to pyrethrum may be in a range of about 1:1 and about 10:1, and the pest control composition may be a single phase. In the same or alternative aspects, the non-aqueous solvent can include propylene glycol n-butyl ether, acetone, an ester of citric acid, isopropyl alcohol, tripropylene glycol methyl ether, propylene carbonate, tripropylene glycol, ethyl lactate, butyl lactate, dipropylene glycol n-propyl ether, or any glycol that has at least 20% water solubility or alcohol that has at least 20% water solubility, or a combination thereof. In additional embodiments, the at least one surfactant can include about 1.1 wt. % to about 8.0 wt. % of a first surfactant and about 0.7 wt. % and to about 6.0 wt. % of a second surfactant.

In various aspects, the at least one surfactant comprises hydrogenated castor oil, ethoxylated linear alcohol #9, polyethylene glycol sorbitan monooleate, polyethylene glycol stearate, sorbitan monooleate, polyethylene glycol stearate, sorbitan monooleate, alcohols, C6-C12, ethoxylated, sodium dodecyl benzenesulfonate, glyceryl monooleate, sorbitan monopalmitate, or any combinations thereof. The pest control composition may be clear and/or colorless, in various aspects. The pest control composition may also include between about 0.10 wt. % and about 0.5 wt. % pyrethrum or pyrethroids and the weight ratio of piperonyl butoxide, or other synergist, to pyrethrum may be about 1:1 and about 10:1, if piperonyl butoxide or other synergist is used.

In certain aspects, the pest control composition can include about 0.50 wt. % to about 3 wt. % piperonyl butoxide, and the solvent can be propylene glycol n-butyl ether. The pest control composition may also include about 0.1 wt. % to about 0.50 wt. % pyrethrum, about 0.5 wt. % to about 3.0 wt. % piperonyl butoxide, the weight ratio of piperonyl butoxide to pyrethrum may be about 1:1 and about 10:1, and the solvent may be propylene glycol n-butyl ether. In addition, the pest control composition may also include at least one propellant. Further, the propellant may be about 1 wt. % to about 15 wt. %, based on the total weight of the composition.

In some aspects of the present disclosure, at least one propellant may be present. The propellant may include nitrogen, compressed air, carbon dioxide, liquified petroleum gas, butane, isobutane, propane, or any combinations thereof. Further, according to some aspects, the pest control composition may include about 0.5 wt. % of pyrethrum and the weight ratio of piperonyl butoxide to pyrethrum may be about 1:1 and about 10:1. The pest control composition may include between about 0.10 wt. % and about 0.5 wt. % pyrethrum and the weight ratio of piperonyl butoxide to pyrethrum may be about 1:1 and about 10:1, in certain aspects. In various aspects, the solvent may be propylene glycol n-butyl ether or another glycol having at least 20% water solubility or alcohol with at least 20% water solubility.

In some aspects of the present disclosure, at least one propellant may be present. The propellant may include nitrogen, compressed air, carbon dioxide, liquified petroleum gas, butane, isobutane, propane, or any combinations thereof. Further, according to some aspects, the pest control composition may include about 0.5 wt. % of pyrethrum and the weight ratio of piperonyl butoxide to pyrethrum may be about 1:1 and about 10:1. The pest control composition may include between about 0.10 wt. % and about 0.5 wt. % pyrethrum and the weight ratio of piperonyl butoxide to pyrethrum may be about 1:1 and about 10:1. According to other aspects of the present disclosure, the pest control composition may include between about 2 wt. % and 3 wt. % piperonyl butoxide, and the solvent may be propylene glycol n-butyl ether or another glycol with at least 20% water solubility or alcohol with at least 20% water solubility. In further embodiments, the pest control composition may be between about 0.1 wt. % and about 0.15 wt. % pyrethrum, between about 1 wt. % and 1.5 wt. % piperonyl butoxide, the weight ratio of piperonyl butoxide to pyrethrum may be between about 9:1 and about 10:1, and the solvent may be propylene glycol n-butyl ether.

In certain aspects, the pest control composition may include between about 0.05 wt. % and about 0.1 wt. % pyrethrum, the weight ratio of piperonyl butoxide to pyrethrum may be in a range of about 1:1 to about 10:1, and the solvent may be propylene glycol n-butyl ether or another glycol with at least 20% water solubility or alcohol with at least 20% water solubility.

Other aspects of the present disclosure provide a method of killing insects which includes applying to a surface in need thereof a composition. The composition includes an active component, a synergist, at least one solvent, at least one surfactant, and water. In this embodiment, the active component may be about 0.075 wt. % to about 1 wt. % of pyrethrum or other active component, the synergist may be about 0.45 wt. % to about 5 wt. % of piperonyl butoxide or other synergist, the at least one solvent may be about 2 wt. % to about 12 wt. %, the at least one surfactant may be about 0.7 wt. % to about 8 wt. %, and the water may be about 74 wt. % to about 91 wt. %. Further, a weight ratio of piperonyl butoxide to pyrethrum may be between about 1:1 and about 10:1, and the composition may be a single phase.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1 shows Formula I of the present disclosure with PNB solvent, ethoxylated linear alcohol #9, and hydrogenated castor oil surfactants; and

FIG. 2 shows Formula E of the present disclosure with acetone solvent, Tween-80, and Span-80 surfactants.

### DETAILED DESCRIPTION OF THE INVENTION

Disclosed herein is a pest control composition including an active ingredient, at least one solvent, at least one surfactant, and water. The composition may also include a synergist. The pest control composition exhibits several desirable features including being water-based, having a single phase which does not require shaking before application, may be clear and/or colorless, and is efficacious as a multi-insect killer (MIK).

### Definitions

As used herein, the term “essentially free of” or “substantially free of” may mean that the indicated material (e.g., VOCs) is present in an amount of no more than 0.1 wt. % by weight of a composition (e.g., a composition, a component, or formulation), or preferably not present at an analytically detectible level in such compositions. It may also include compositions where the indicated material is present only as an impurity of one or more of the materials deliberately added to such compositions.

The term “about,” as used herein, refers to variation in the numerical quantity that may occur, for example, through typical measuring and liquid handling procedures used for making concentrates or use solutions in the real world, through inadvertent error in these procedures, through differences in the manufacture, source, or purity of the ingredients used to make the compositions or carry out the methods, and the like. The term “about” may also encompass amounts that differ due to different equilibrium conditions for a composition resulting from a particular initial mixture. In one embodiment, the term “about” refers to a range of values±5% of a specified value.

The terms “weight percent,” “wt-%,” “percent by weight,” “% by weight,” and variations thereof, as used herein, refer to the concentration of a substance or component as the weight of that substance or component divided by the total weight, for example, of the composition or of a particular component of the composition, and multiplied by 100. It is understood that, as used herein, “percent,” “%,” and the like may be synonymous with “weight percent” and “wt-%.”

An active ingredient (AI) or active component is a component of the composition which imparts the intended effect of the composition. In the present disclosure, the intended effect of the composition includes pest control by pest knockdown and/or pest mortality. Insecticide active components may be categorized into two types: immediate knock-down (KD) (i.e., instant action, but insect may recover) or residual kill (e.g., continues killing for some time period after application). In some instances, AIs may include natural pyrethrin (also referred to as “pyrethrum” or “Py” herein), prallethrin (ETOC®, Sumitomo Chemical Co., Ltd., Tokyo Nihombashi Tower, 2-7-1, Nihonbashi, Chuo-ku, Tokyo 103-6020, Japan), d-tetramethrin (Neo Pynamin® Forte, Sumitomo Chemical Co., Ltd., Tokyo, Nihombashi Tower, 2-7-1, Nihonbashi, Chuo-ku, Tokyo 103-6020, Japan), propoxur, bendiocarb, imiprothrin, transfluthrin, and metofluthrin. Known residual AIs include d-phenothrin (Sumithrin®, Sumitomo Chemical Co., Ltd., Tokyo Nihombashi Tower, 2-7-1, Nihonbashi, Chuo-ku, Tokyo 103-6-2-, Japan), cypermethrin, cyfluthrin, beta-cyfluthrin, and deltamethrin, Fipronil, indoxacarb, d-cis/trans allethrin, d-trans allethrin, tetramethrin, Cyphenothrin, deltamethrin, etofenprox, esfenvalerate, lambda-cyhalothrin, permethrin, dimefluthrin, meperfluthrin, a synergist that may include piperonyl butoxide and/or MGK 264. Preferably, the active component may have anti-pest effects on multiple insects. In some instances, the active component may be about 0.015 wt. % to about 1.50 wt. %, about 0.020 wt. % to about 1.35 wt. %, about 0.025 wt. % to about 1.50 wt. %, 0.1 wt. % to about 1.50 wt. %, about 0.1 wt. % to about 1.0 wt. %, and about 0.020 wt. % to about 0.125 wt. %, based on the total weight of the composition. In some instances, the active component may be about 0.1 wt % to about 1.0 wt. % of Pyrethrin in aerosol formulations. While specific values chosen for this example are recited, it is to be understood that, within the scope of the disclosure, the concentrations of active component may vary to suit different applications.

Synergists are components which support and/or help killing activity and mortality. Without being bound by any particular theory, it is believed that synergists help increase the effectiveness of the insecticide by preventing insect enzymes from breaking down the insecticide too quickly. Examples of synergists which may be used in compositions disclosed herein include, but are not limited to, piperonyl butoxide (PBO) and Pyrodone (MGK-264). MGK-264 can also be referred to as N-(2-Ethylhexyl)-5-norbornene-2,3-dicarboximide. In some aspects, the synergist may be present in a range of about 0.25 wt. % to about 7.00 wt. %, about 0.020 wt. % to about 1.35 wt. %, about 0.025 wt. % to about 1.50 wt. %, about 0.020 wt. % to about 0.125 wt. %, about 0.1 wt. % to about 5 wt. %, about 0.35 wt. % to about 5 wt. %, about 0.45 wt. % to about 2.50 wt. %, about 0.15 wt. % to about 4 wt. %, or about 0.50 wt. % to about 3 wt. %, based on the total weight of the composition. While specific values chosen for this example are listed, it is to be understood that, within the scope of the disclosure, the concentrations of synergists may vary to suit different applications.

The active ingredient and synergist may be formulated in a ratio to maximize efficacy of the pest control compositions disclosed herein. In some instances, the ratio of synergist to active ingredient, when a synergist is used, may be from about 0.5 to about 25. In some instances, the ratio of synergist to active ingredient may be from no less than 1 to no greater than 20 (i.e., PBO:Py of no less than about 1:1 to no greater than about 20:1). Preferably, the ratio of synergist to active ingredient may be no less than about 1 and no greater than about 10 (i.e., PBO:Py of no less than about 1:1 to no greater than about 10:1). While specific values chosen for this example are listed, it is to be understood that, within the scope of the disclosure, the ratio of synergist to active component may vary to suit different applications.

A solvent is defined as a substance, usually liquid, which is capable of dissolving one or several substances into a solution or a mixture, such as an emulsion. The composition disclosed herein may contain water and at least one non-aqueous solvent. In some instances, non-aqueous solvents may include acetone, propylene glycol n-butyl ether (PNB), Acetyltri-n-butyl citrate (e.g., Citroflex®, Phizer & Co., Inc., Delaware 11 Bartlett St. Brooklyn, NY (e.g., citric acid esters), or any propylene-based glycol ether, an alcohol with more than 20% water solubility, and/or any combinations thereof. In one or more aspects, the non-aqueous solvent can be present in an amount of about 0 wt. % to about 30 wt. %, 0 wt. % to about 20 wt. %, 0 wt. % to about 15 wt. %, 0 wt. % to about 12 wt. %, 1 wt. % to about 30 wt. %, 1 wt. % to about 20 wt. %, 1 wt. % to about 15 wt. %, 1 wt. % to about 12 wt. % or about 2 wt. %, about 3 wt. %, about 4 wt. %, about 5 wt. %, about 6 wt. %, about 7 wt. %, or about 8 wt. %. The compositions disclosed herein may contain about 70 wt. % to about 95 wt. %, about 80 wt. % to about 93 wt. %, about 81 wt. % to about 92 wt. %, or about 82 wt. % to about 92 wt. % of water, based on the total weight of the composition, making the compositions water-based. Water compositionally includes H₂O but may further include additional components. Additional components may include compounds for corrosion inhibition or pH adjustment, such as anhydrous disodium phosphate, potassium dihydrogen phosphate, or ammonium hydroxide. Corrosion inhibitors may also include sodium benzoate, sodium nitrite, or ammonium benzoate. Additional components may also include preservatives (i.e., methylisothiazolinone (MIT), methylchloroisothiazolinone (CMIT), benzisothiazolinone (BIT), octylisothiazolinone (OIT), dichlorooctylisothiazolinone (DCOIT), potassium sorbate, phenoxyethanol, paraben, formaldehyde, sorbic acid, methylparaben, benzyl alcohol, benzoic acid, diazolidyl urea, DMDM hydantoin, BHT, imidazolidinyl urea, proplyparaben, triclosan, quaternium-15, iodopropynyl butylcarbmate, dehydroacetic acid, propylene glycol, 1,2-octanediol, isothiazolinone, butylparaben, butylated hydroxyanisole, calcium propionate, ammonium benzoate, or sodium benzoate. Additional components may also include antioxidants, including Vitamin E. The additional components in water may be less than 1.1 wt %, less than 1.0 wt. %, less than 0.9 wt. %, or less than 0.8 wt. %, based on the weight of the total water component. The compositions disclosed herein may contain about 1 wt. % to about 12 wt. %, about 2 wt. % to about 6 wt. %, or about 3 wt. % to about 5 wt. % of the at least one non-aqueous solvent, based on the total weight of the composition. While specific values chosen for this example are recited, it is to be understood that, within the scope of the disclosure, the concentrations of water and non-aqueous solvents may vary to suit different applications.

An emulsion is defined as a single-phase mixture of two or more liquids that are normally immiscible (unmixable or unblendable) owing to liquid-liquid phase separation. For example, an emulsion may contain droplets of a first liquid dispersed within a second liquid. In some instances, surfactants and/or emulsifiers may enhance the stability of an emulsion so that the emulsion is stable for long durations of time. A “reversible emulsion” or “stable emulsion” composition has the property of returning to or staying in a substantially non-separating, and possibly clear, single phase at room temperature with little (i.e., less than 10 seconds) to no physical agitation, such as stirring or shaking. Conversely, an unstable emulsion may not remain (demulsify) or fails to remain as a clear, and/or single phase at room temperature (23° C.) without significant agitation (i.e., more than 10 seconds) if exposed to elevated (e.g., above 30° C.) or reduced (e.g., below 4° C.) temperatures. The compositions disclosed herein may be preferably a single-phase emulsion. In some aspects, the compositions may be stable, single-phase emulsions.

A surfactant is a substance which reduces the surface tension of a liquid in which it is dissolved and thereby increases its spreading and wetting properties. As a class of emulsifiers, surfactants may enhance the miscibility of disparate liquids to form an emulsion. The composition disclosed herein may contain at least one surfactant. In some instances, the at least one surfactant may include but not be limited to hydrogenated castor oil, ethoxylated linear alcohol #9, polyethylene glycol stearate, stearic acid, sorbitan monooleate (e.g., Span®-80 produced by Sigma-Aldrich, Spruce Street, Saint Louis, MO 63103, hereinafter, “Span-80,” “span-80,” “Span 80,” or “span 80”), and polyethylene glycol sorbitan monooleate (e.g., Tween®-80 produced by Sigma-Aldrich, Spruce Street, Saint Louis, MO 63103 (hereinafter, “Tween-80,” “Tween 80,” “tween 80,” or “tween-80”). polyethylene glycol stearate, alcohols C6-C12, ethoxylated, sodium dodecyl benzenesulfonate, glyceryl monooleate, sorbitan monopalmitate, or combinations thereof.

The compositions disclosed herein may contain preferred combinations of surfactants. For example, the first one or more surfactants may be selected from hydrogenated castor oil or Span 80. The second one or more surfactants may be selected from ethoxylated linear alcohol #9, polyethylene glycol sorbitan monooleate, sorbitan monooleate, or polyethylene glycol stearate. In some examples, the first one or more surfactants may be about 0.5 wt. % to about 6.0 wt. % and the second one or more surfactants may be about 0.5 wt. % to about 8.0 wt. %, based on the total weight of the composition. In other examples, the at least one surfactant is about 0.7 wt. % to about 5.5 wt. %, about 0.5 wt. % to about 5.0 wt. %, or about 1.0 wt. % to about 5.0 wt. %, based on the total weight of the composition. While specific values are chosen for this example are listed, it is to be understood that, within the scope of the disclosure, the concentrations of at least one surfactant may vary to suit different applications.

In some cases, the one or more surfactants include an oil phase and a surfactant. For example, ethoxylated linear alcohol #9 and hydrogenated castor oil may be used as the surfactant and oil phase, respectively. In some instances, it is desirable to formulate the oil phase and surfactant in a ratio or ratios to optimize the stability of the resulting emulsion formed. For example, the % oil phase surfactant may be about 0.7 to about 8.0 and % surfactant ratio may be about 0.85 to about 0.88, about 0.80 to about 0.90, about 0.83 to about 0.91, about 1.80 to about 1.90, about 0.55 to about 1.90, or about 0.60 to about 1.85, or about 1.70 to about 1.90. In some aspects, the one or more surfactants can include a water phase surfactant. In such an aspect, the water phase surfactant can include, but is not limited to, Tween 80, Tween 20, Tween 65, ethoxylated stearic acid. Examples of combinations of one or more surfactants include, but are not limited to, polyethylene glycol stearate and sorbitan monooleate, Tween-80 and sorbitan monooleate, sorbitan monooleate and ethoxylated linear alcohol #9, and ethoxylated linear alcohol #9 and hydrogenated castor oil.

In some instances, the composition may be applied in an aerosol-free composition, such as in a trigger spray application. In other instances, the composition may further comprise a propellant for application as an aerosol. In some cases, the propellant may include a gas that is the vapor of a liquid with boiling point slightly lower than room temperature, compressed gases, compressed inert gases (e.g., nitrogen), hydrocarbons (e.g., propane, butane, or isobutane), halogenated hydrocarbons (e.g., haloalkanes, hydrofluoroalkanes, hydrofluoroolefins), dimethyl ether, methyl ethyl ether, nitrous oxide, carbon dioxide, compressed air (i.e., compressed ambient air), or liquified petroleum gas. In some cases, the composition may contain about 1.0 wt. % to about 15.0 wt. %, about 1.5 wt. % to about 4.5 wt. %, about 2 wt. % to about 6 wt. %, about 0.5 wt. % to about 4.0 wt. %, about 1.0 wt. % to about 20 wt. %, about 1.0 wt. % to about 15 wt. %, about 5.0 wt. % to about 15 wt. %, about 2.0 wt. % to about 15 wt. %, about 5.0 wt. % to about 20 wt. %, or about 3.0 wt. % to about 15 wt. % propellant, based upon the total weight of the composition. In another aspect, the disclosed compositions may not contain volatile organic compounds (VOCs). The California Air Resources Board (CARB) definition for low vapor pressure (LVP) substances is VOCs that have a vapor pressure less than 0.1 mmHg at 20° C. or a boiling point greater or equal to 216° C. The U.S. EPA definition is VOCs that have a vapor pressure<0.1 mmHg at 20° C. or a melting point>20° C. and does not sublime, if the vapor pressure is not known.

The compositions disclosed herein may be substantially free from VOCs. In other cases, the compositions may contain less than 0.1 wt. % up to 16% VOCs, less than 0.1 wt. % VOCs, less than 1.0 wt. % VOCs, less than 1.5 wt. % VOCs, less than 2 wt. % VOCs, less than 2.5 wt. % VOC, less than 3.0 wt. % VOCs, less than 5 wt. % VOCs, based on the total weight of the composition.

Customers purchasing pest control compositions desire a clear and/or colorless composition. Clear compositions are transparent to light and are substantially free of precipitants, solids, aggregates, other suspended particles, or suspended droplets which may diffract light and result in an opaque composition. Some of the compositions disclosed herein may be substantially clear compositions, in various aspects. A colorless solution is substantially free of color. By way of example, pure water is colorless. In certain aspects, the compositions disclosed herein, in many cases, may be substantially colorless compositions. In some instances, the compositions disclosed herein may be both clear and colorless. In one or more aspects, certain compositions disclosed herein they may be opaque to translucent.

In another aspect of the disclosed technology, the compositions disclosed herein may be used for pest control. The above-described compositions are effective at eliciting knockdown or killing a range of insects (e.g., acting as an insecticide). The compositions may have knockdown or mortality efficacies in one or more pests, including flies, ants, cockroaches, spiders, mosquitoes, fruit flies, moths, multi-colored Asian lady beetles, beetles, gnats, wasps, hornets, pill bug, sow bugs, crickets, silverfish, millipedes, centipedes, or any combination thereof. In some embodiments, the emulsion composition may demonstrate pest control efficacy on Campanotus floridanus, Blatella germanica, Aedes aegypti, Musca domestica, Rhipicephalus sanguineus, Euborellia annulipes, Thermobia domestica, Monomorium pharaonic, Linepithema humile, Parasteatoda tepidariorum, Periplaneta americana, Drosophila melanogaster, Plodia interpunctella, or any combination thereof.

In some embodiments, the emulsion composition may be applied to a person, a surface, an area, or an animal in need of pest control. The current disclosure also describes a method of killing insects including applying to a surface in need thereof an aqueous and/or reversible emulsion composition for pest control. “Applying” may include wiping, spraying, pouring, or orienting the surface closely adjacent to the composition, or otherwise exposing a surface to the composition. Spraying the composition may include spraying with a trigger spray mechanism, hose-end attachment, squeeze bottle or by an aerosol.

Surprisingly, it was determined that the compositions disclosed herein are effective at knocking down and/or killing multiple types of insects (e.g., crawling insects and flying insects), with pest control compositions including an active ingredient, at least one non-aqueous solvent, at least one surfactant, and water. The compositions effective knocking down and/or killing multiple types of insects may also include a synergist. In some aspects, the pest control composition is a stable emulsion (i.e., having a single phase) which does not require shaking before use.

The term “water” as used herein means an inert or fluid material, which can be inorganic or organic and of synthetic or natural origin, with which the active compound is mixed or formulated to facilitate its application to the host, area, or other object to be treated, or to facilitate its storage, transport and/or handling. In general, any of the materials customarily employed in formulating repellents, pesticides, herbicides, or fungicides, are suitable. Water compositionally includes H₂O but may further include additional components. Additional components may include compounds for corrosion inhibition, pH adjustment, formulation preservatives or fragrance.

As used herein, the term “killing” or “kill” refers to the ability of at least one active ingredient in a composition to render an insect dead.

As used herein, the term “knocking down” or “knockdown” (kd) refers to the ability of the composition described herein to render an insect immobile. For example, a flying insect contacted with a composition described herein is said to be “knocked-down” if it falls to the ground and is unable to fly, even though it may be able to move body parts, so it cannot be categorized as completely paralyzed. The insect's ability to move, feed, reproduce, spread disease, or irritate is severely curtailed during the period in which it is knocked down.

As used herein, the term “emulsifier,” or surfactant, refers to a substance that stabilizes an emulsion by increasing its kinetic stability and comprises a hydrophilic (water-soluble) portion and a lipophilic (oil-soluble) portion. Common examples of emulsifiers include, but are not limited to, sodium lauryl sulfate, saponin, ethoxylated alcohols, ethoxylated fatty esters, alkoxylated glycols, ethoxylated fatty acids, ethoxylated castor oil, glyceryl oleates, carboxylated alcohols, carboxylic acids, fatty acids, ethoxylated alkylphenols, fatty esters, sodium dodecylsulfide, other fatty acid-based surfactants, other natural or synthetic emulsifiers, and combinations thereof.

As used herein, the term “repelling” or “repel” refers to the ability of the compositions described herein to cause a pest or insect to deviate away from or avoid a surface, object, or insect breeding site treated with said composition.

### EXAMPLES

The examples herein are intended to illustrate certain embodiments of the formulations and methods of producing the formulations to one of ordinary skill in the art and should not be interpreted as limiting in the scope of the disclosure set forth in the claims. The formulations, and the methods of making thereof, may comprise the following non-limiting examples.

### Example 1

Several formulations were tested to showcase the stability of formulations of the present disclosure. For example, a formulation according to that outlined in Table 1 below was formulated and then observed to determine whether residue formed. In particular, three solvents were tested, including acetone, propylene glycol n-butyl ether, and citroflex. Then the optimal surfactants for each solvent was determined. For propylene glycol n-butyl ether, the optimal surfactants included hydrogenated castor oil and ethoxylated linear alcohol #9. For acetone, the optimal surfactants included Span® 80, Tween® 80, or sorbitan monooleate. Last, the optimal surfactants for Citroflex® (e.g., C₂₀H₃₄O₈) were polyethylene glycol stearate and Span® 80.

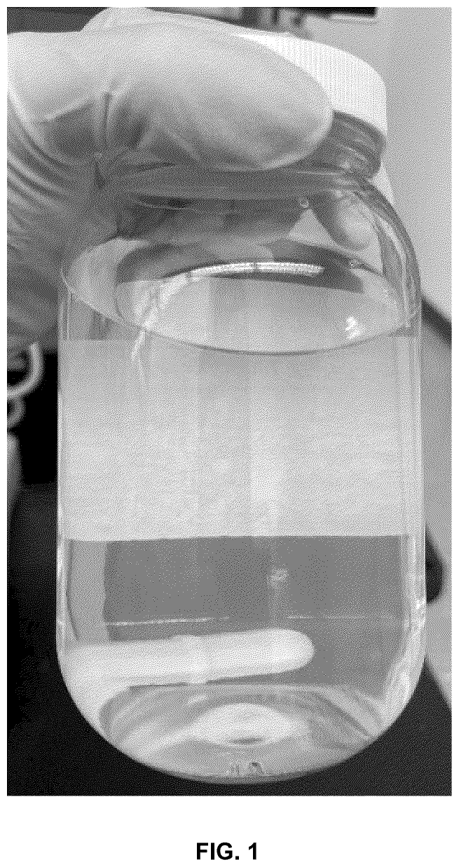

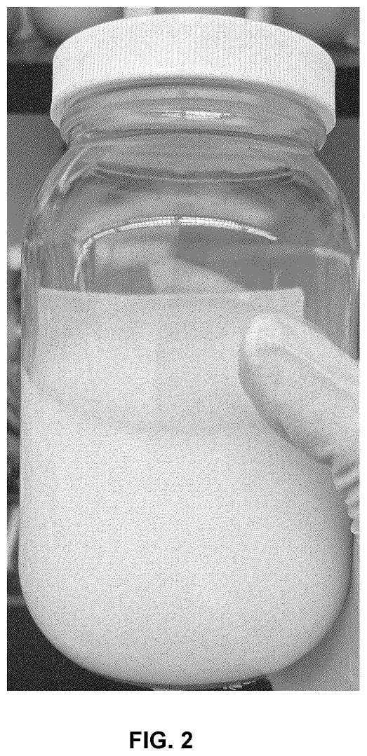

Additionally, FIG. 1 is a visual representation of a formulation (i.e., Formulation I) according to the weight percentages shown in Table 1, which included propylene glycol n-butyl ether as the solvent. Further, as shown in FIG. 1, the formulation had a clear appearance and minimal residue. FIG. 2 is a visual representation of a formulation according to weight percentages shown in Table 1, which included acetone as the solvent. Here, the formulation is less clear compared to that shown in FIG. 1, but still may be used as a water-based pest control composition.

TABLE 1
Outline of example water-based, single
phase pest control composition.

| Component | Ingredient Options | Weight % |
|---|---|---|
| Water | Purified Water | q.s. |
| | Aqueous Intermediate (aerosol only) | |
| Solvent | Propylene Glycol n-Butyl Ether (PnB) | 2-5 |
| | Acetyltri-n-butyl citrate (Citroflex) | |
| | Acetone. | |
| Surfactant 1 | Hydrogenated Castor Oil | 1.1-4.2 |
| | Span 80 (sorbitan monooleate) | |
| Surfactant 2 | Secondary Alcohol Ethoxylate, 9EO | 0.7-5.5 |
| | Tween 80 (polyoxyethylene | |
| | sorbitan monooleate) | |
| | Polyethylene glycol stearate | |
| Active | Natural Pyrethrum | 0.075-0.25 |
| Ingredient | | |
| Synergist | Piperonyl Butoxide (PBO) | 0.45-2.5 |
| Propellant | Nitrogen | filled to |
| (aerosol only) | | 100 psi |

### Example 2

Next, the stability of formulations of the present disclosure were further tested. In this example, numerous formulations were tested to determine if a single phase and clear formulation could be produced.

### Formulations

The first round of samples were three different solvents including acetone, PNB, and Citroflex®. Several surfactants were selected and used in combination with the solvents, including hydrogenated castor oil, ethoxylated linear alcohol #9, polyethylene glycol stearate, sorbitan monooleate (Span-80), and polyoxyethylene sorbitan monooleate (Tween-80). PBO was used as the synergist in the formulations and MGK pyrethrum 50% was also used as an active. Tables 2-6 provide the tested formulations, i.e., Formulations A-O.

Formulation A included a formulation according to that listed in Table 2. Further, this formulation was batched at room temperature. Acetone, pyrethrum, and then PBO was added and mixed for about 10 minutes at 400 RPM. Afterwards, the surfactants were added and then the formulation was mixed for an additional 10 minutes at 400 RPM. Last, water was added and the formulation was again mixed for 10 minutes at 600 RPM. Formulation A resulted in a single phase mixture with a white milky appearance.

Formulation B included a formulation according to that listed in Table 2. Further, this formulation was batched at room temperature. PNB, pyrethrum, and then PBO were mixed for about 10 minutes at 400 RPM. Afterwards, the surfactants were added, and the formulation was mixed for an additional 10 minutes at 400 RPM. Last, water was added, and the formulation was again mixed for 10 minutes at 600 RPM. Formulation B resulted in a single phase, white clear liquid.

Formulation C included a formulation according to that listed in Table 2. Further, this formulation was batched at room temperature. Acetone, pyrethrum, and then PBO were mixed for about 10 minutes at 400 RPM. Afterwards, the surfactants were added, and the formulation was mixed for an additional 10 minutes at 400 RPM. Last, water was added and the formulation was again mixed for 10 minutes at 600 RPM. Formulation C resulted in a single phase, white milky liquid.

TABLE 2
Formulations A-C.

| | | Formulas | | |
|---|---|---|---|---|
| Material | Function | A | B | C |
| Acetone | Solvent | 5.00 | — | 5.00 |
| Propylene Glycol | Solvent | — | 5.00 | — |
| n-Butyl Ether | | | | |
| Acetyltri-n-butyl Citrate | Solvent | — | — | — |
| Pyrethrum, 50% | Active Ingredient | 0.15 | 0.15 | 0.15 |
| Piperonyl Butoxide | Synergist | 0.45 | 0.45 | 0.45 |
| Span 80 | Surfactant 1 | 1.18 | — | — |
| Hydrogenated Castor Oil | Surfactant 1 | — | 1.40 | 3.53 |
| Secondary Alcohol | Surfactant 2 | — | 0.70 | — |
| Ethoxylate, 9EO | | | | |
| Tween 80 | Surfactant 2 | — | — | — |
| Polyethylene Glycol | Surfactant 2 | 1.82 | — | 5.47 |
| Stearate | | | | |
| Water | Water | 91.40 | 92.30 | 85.40 |
| | Total | 100.00 | 100.00 | 100.00 |
| | Surfactant:Oil | 5.72 | 4.00 | 17.14 |
| | PBO:Py | 6 | 6 | 6 |

Formulation D included a formulation according to that listed in Table 3. Further, this formulation was batched at room temperature. PNB, pyrethrum, and then PBO were mixed for about 10 minutes at 400 RPM. Afterwards, the surfactants were added, and the formulation was mixed for an additional 10 minutes at 400 RPM. Last, water was added, and the formulation was again mixed for 10 minutes at 600 RPM. Formulation D resulted in a single phase, white milky liquid.

Formulation E is shown in Table 3. This formulation was batched at room temperature. First, acetone, pyrethrum, and then PBO were mixed for about 10 minutes at 400 RPM. Afterwards, the surfactants were added, and the formulation was mixed for an additional 10 minutes at 400 RPM. Last, water was added and the formulation was again mixed for 10 minutes at 600 RPM. Formulation E resulted in a single phase, white milky liquid.

Formulation F is shown in Table 3. Formulation F was batched at room temperature. First, PNB, pyrethrum, and then PBO were mixed for about 10 minutes at 400 RPM. Afterwards, the surfactants were added, and the formulation was mixed for an additional 10 minutes at 400 RPM. Last, water was added and the formulation was again mixed for 10 minutes at 600 RPM. Formulation F resulted in a single phase, white milky liquid.

TABLE 3
Formulations D-F.

| | | Formulas | | |
|---|---|---|---|---|
| Material | Function | D | E | F |
| Acetone | Solvent | — | 5.00 | — |
| Propylene Glycol | Solvent | 5.00 | — | 5.00 |
| n-Butyl Ether | | | | |
| Acetyltri-n-butyl Citrate | Solvent | | — | — |
| Pyrethrum, 50% | Active Ingredient | 0.15 | 0.15 | 0.15 |
| Piperonyl Butoxide | Synergist | 0.45 | 0.45 | 0.45 |
| Span 80 | Surfactant 1 | — | 1.40 | 1.40 |
| Hydrogrenated | Surfactant 1 | 4.20 | — | — |
| Castor Oil | | | | |
| Secondary Alcohol | Surfactant 2 | 2.10 | | |
| Ethoxylate, 9EO | | | | |
| Tween 80 | Surfactant 2 | — | 1.60 | 1.60 |
| Polyethylene Glycol | Surfactant 2 | — | — | — |
| Stearate | | | | |
| Water | Water | 88.10 | 91.40 | 91.40 |
| | Total | 100.00 | 100.00 | 100.00 |
| | Surfactant:Oil | 12.00 | 5.71 | 5.71 |
| | PBO:Py | 6 | 6 | 6 |

Formulation G is shown in Table 4 below. Formulation G was batched at room temperature. First, PNB, pyrethrum, and then PBO were mixed for about 10 minutes at 400 RPM. Afterwards, the surfactants were added, and the formulation was mixed for an additional 10 minutes at 400 RPM. Last, water was added and the formulation was again mixed for 10 minutes at 600 RPM. Formulation G resulted in a single-phase that was white in pigment and relatively clear.

Formulation H is shown in Table 4 below. Formulation H was batched at room temperature. For this formulation, citroflex, pyrethrum, and then PBO were mixed for about 10 minutes at 400 RPM. Afterwards, the surfactants were added, and the formulation was mixed for an additional 10 minutes at 400 RPM. Last, water was added and the formulation was again mixed for 10 minutes at 600 RPM. Formulation H was a single-phase, white milky liquid.

Formulation I is shown in Table 4 below. Formulation I was batched at 100 degrees Fahrenheit. For this formulation, PNB, pyrethrum, and then PBO were mixed for about 10 minutes at 400 RPM. Afterwards, the surfactants were added, and the formulation was mixed for an additional 10 minutes at 400 RPM. Last, water was added and the formulation was again mixed for 10 minutes at 600 RPM with heating to 100 degrees Fahrenheit. Formulation I was a little hazy, but mainly clear and no solids were present.

TABLE 4
Formulations G-I.

| | | Formulas | | |
|---|---|---|---|---|
| Material | Function | G | H | I |
| Acetone | Solvent | — | — | — |
| Propylene Glycol | Solvent | 5.00 | — | 5.00 |
| n-Butyl Ether | | | | |
| Acetyltri-n-butyl Citrate | Solvent | — | 5.00 | — |
| Pyrethrum, 50% | Active Ingredient | 0.15 | 0.15 | 0.15 |
| Piperonyl Butoxide | Synergist | 0.45 | 0.45 | 0.45 |
| Span 80 | Surfactant 1 | 1.22 | 1.18 | |
| Hydrogrenated | Surfactant 1 | — | — | 4.20 |
| Castor Oil | | | | |
| Secondary Alcohol | Surfactant 2 | 1.78 | — | 2.10 |
| Ethoxylate, 9EO | | | | |
| Tween 80 | Surfactant 2 | — | — | — |
| Polyethylene Glycol | Surfactant 2 | — | 1.82 | — |
| Stearate | | | | |
| Water | Water | 91.40 | 91.40 | 88.10 |
| | Total | 100.00 | 100.00 | 100.00 |
| | Surfactant:Oil | 5.71 | 5.71 | 12.00 |
| | PBO:Py | 6 | 6 | 6 |

Formulation J is shown in Table 5. Formulation J was batched at 100 degrees Fahrenheit, as described below. First, PNB, Citroflex®, pyrethrum, and then PBO were mixed for about 10 minutes at 400 RPM. Afterwards, the surfactants were added, and the formulation was mixed for an additional 10 minutes at 400 RPM. Last, water was added and the formulation was again mixed for 10 minutes at 600 RPM. Formulation J resulted in a single phase solution, but this formulation had a solid white color.

Formulation K is shown in Table 5 below. Here, Citroflex®, acetone, pyrethrum, and PBO were mixed for 10 minutes and a clear yellow solution resulted. Next, surfactants were added, and the formulation was mixed for 10 minutes, which resulted in a darker yellow, but relatively clear solution. Last, water was added, which turned the solution opaque white. With that said, the formulation was a single-phase formulation.

Formulation L is shown in Table 5 below. Formulation L was formed by adding acetone, pyrethrum, and PBO together and mixing for 10 minutes, which resulted in a clear yellow formulation. Next, surfactants were added and mixed with the formulation for 10 minutes, which created a darker yellow, but clear, formulation. Last, water was added to the formulation, which turned the formulation into an opaque white mixture, which appeared single phase.

TABLE 5
Formulations J-L.

| | | Formulas | | |
|---|---|---|---|---|
| Material | Function | J | K | L |
| Acetone | Solvent | — | 3.00 | 5.00 |
| Propylene Glycol | Solvent | 5.00 | — | — |
| n-Butyl Ether | | | | |
| Acetyltri-n-butyl Citrate | Solvent | 3.00 | 2.00 | — |
| Pyrethrum, 50% | Active Ingredient | 0.15 | 0.15 | 1.00 |
| Piperonyl Butoxide | Synergist | 0.45 | 0.45 | 3.00 |
| Span 80 | Surfactant 1 | — | 1.40 | 1.40 |
| Hydrogrenated | Surfactant 1 | 1.40 | — | — |
| Castor Oil | | | | |
| Secondary Alcohol | Surfactant 2 | 0.70 | — | — |
| Ethoxylate, 9EO | | | | |
| Tween 80 | Surfactant 2 | — | 1.60 | 1.60 |
| Polyethylene Glycol | Surfactant 2 | — | — | — |
| Stearate | | | | |
| Water | Water | 89.30 | 91.40 | 88.00 |
| | Total | 100.00 | 100.00 | 100.00 |
| | Surfactant:Oil | 4.00 | 5.71 | 0.86 |
| | PBO:Py | 6 | 6 | 6 |

Formulation M is shown in Table 6 below. Formulation M was made by adding PNB, pyrethrum, PBO, and then mixed for 10 minutes to create a clear yellow formulation. Next, the surfactants were added to the mixture, and the formulation was mixed for an additional 10 minutes while heating to 40 degrees Celsius, which also created a clear yellow formulation. Last, water was added, which immediately turned the formulation white.

Formulation N is shown in Table 6 below. Formulation N was created by adding PNB, pyrethrum, and PBO. Next, the formulation was mixed for 10 minutes, which created a clear yellow mixture. Further, surfactants were added, and the formulation was mixed for an additional 10 minutes while heating to 40 degrees Celsius. This created a formulation that was also clear and yellow in color. Last, water was added to the formulation, and the formulation was mixed for another 10 minutes while the formulation was heated to 40 degrees Celsius. This created a clear and single phase solution. Further, surfactants were then added, and the formulation was mixed for an additional 10 minutes, which created a darker yellow, but relatively clear, formulation.—Last, water was added, which turned the formulation opaque, but the formulation was still a single phase formulation.

TABLE 6
Formulations M-O.

| | | Formulas | | |
|---|---|---|---|---|
| Material | Function | M | N | O |
| Acetone | Solvent | — | — | 5.00 |
| Propylene Glycol n-Butyl | Solvent | 5.00 | 5.00 | — |
| Ether | | | | |
| Acetyltri-n-butyl Citrate | Solvent | — | — | — |
| Pyrethrum, 50% | Active | 1.00 | 0.15 | 0.15 |
| | Ingredient | | | |
| Piperonyl Butoxide | Synergist | 3.00 | 0.30 | 0.23 |
| Span 80 | Surfactant 1 | — | — | — |
| Hydrogrenated Castor Oil | Surfactant 1 | 4.20 | 4.20 | 1.40 |
| Secondary Alcohol | Surfactant 2 | 2.10 | 2.10 | — |
| Ethoxylate, 9EO | | | | |
| Tween 80 | Surfactant 2 | — | — | 1.60 |
| Polyethylene Glycol | Surfactant 2 | — | — | — |
| Stearate | | | | |
| Water | Water | 84.70 | 88.25 | 91.63 |
| | Total | 100.00 | 100.00 | 100.00 |
| | Surfactant:Oil | 1.80 | 16.80 | 10.00 |
| | PBO:Py | 6 | 4 | 3 |

The stability results of formulations A-O are shown in Tables 7-8.

### Experimental Procedure & Testing

As discussed above, Formulations A-O were prepared using specific procedures. In particular, Formulations A-O were produced using a benchtop hot plate and magnetic stir bar, glass beakers or glass jars with plastic lids, pipets, and a scale sensitive to the hundredth of a gram. Next, as previously mentioned, solvents were first added to the glass jars or beakers with magnetic stir bars. Then, PBO and pyrethrum 50% may be added to the solvent(s) and the mixture was mixed for about 10 minutes. Afterwards, surfactants were added, and the mixtures were mixed for an additional 10 minutes. Some batches required heating, and in such circumstances, the hot plate was turned on during this step and the liquid was heated to a temperature of approximately 40 degrees Celsius, for example. Last, water was added to the mixture and mixed for an additional 10 minutes. Again, some batches required heating, and in such circumstances, the hot plate was turned on during this step and the liquid was heated to a temperature of approximately 40 degrees Celsius, for example. After the formulations were prepared, the formulations were portioned out into samples, some of which were maintained at room temperature, some of which were placed in a freezer, and some of which were placed in a refrigerator. Additionally, the freezer and the refrigerator samples were cycled three times to confirm their stability. Visual observations of the stability of the samples were taken over time.

The results of this testing are shown in Tables 7 and 8 below. In general, the preliminary results showed many prototypes were stable for up to three months. Further, when observing what formulas were stable the following was found in connection to each solvent.

Propylene Glycol n-butyl Ether (PNB) Solvent. When using ethoxylated linear alcohol #9 and hydrogenated castor oil as the surfactants, none of the formulas were stable without heating. Further, with heating, Formulas N and I were stable for several months. More so, these formulations had a ratio of % oil phase to % surfactant ratio of 0.85-0.88. Further, samples with higher oil:surfactant ratios were not stable and it is recommended that the amount of surfactant be increased to the 0.85-0.88 range. Further, when using Span-80 and Ethoxylated Linear Alcohol #9, Sample G was stable for over three months at RT with 1.22% Span-80 and 1.78% ethoxylated linear alcohol #9, which is an % oil phase: % surfactant ratio of 1.87

Acetone Solvent. Samples made with acetone solvents were much easier to get and remain in a stable emulsion. Further, when changing between polyethylene glycol stearate and Tween-80, both surfactants produced stable samples. More so, when looking at the oil:surfactants ratio, if the % oil phase: % surfactant ratio was 0.61-1.84, the samples were stable for over three months for all formulations. Sample L was made with much more oil and had a % oil phase: % surfactant ratio of 2.83. This sample was not stable and indicates this ratio is too high for emulsion stability.

Citroflex®. Typically, Citroflex® is an expensive solvent and only one sample with Citroflex® was tested, i.e., Sample H. Here, using polyethylene glycol stearate and Span-80 at an % oil phase: % surfactant ratio of 1.84 produced a formulation that was stable for over three months.

In addition to the tables below, FIG. 1 is an image of Formulation I with PNB solvent, ethoxylated linear alcohol #9, and hydrogenated cast oil surfactants. Further, FIG. 2 is an image of Formulation E with acetone solvent, Tween-80, and Span-80 surfactants.

TABLE 7
Stability Results of Formulations A-O.

| | Batching | Surfactant/ | | |
|---|---|---|---|---|
| Formula | Temp. | Oil | Solvent | Appearance |
| N | 40° C. | 16.80 | PnB | Clear |
| I | 40° C. | 12.00 | PnB | Clear |
| D | Ambient | 12.00 | PnB | Semi- |
| | | | | transparent |
| G | Ambient | 5.71 | PnB | Semi- |
| | | | | transparent |
| B | Ambient | 4.00 | PnB | Semi- |
| | | | | transparent |
| C | Ambient | 17.14 | Acetone | Opaque white |
| O | Ambient | 10.00 | Acetone | Opaque white |
| A | Ambient | 5.72 | Acetone | Opaque white |
| E | Ambient | 5.71 | Acetone | Opaque white |
| L | Ambient | 0.86 | Acetone | Opaque white |
| F | Ambient | 5.71 | PnB | Opaque white |
| M | 40° C. | 1.80 | PnB | Opaque white |
| H | Ambient | 5.71 | Citroflex | Opaque white |
| K | Ambient | 5.71 | Citroflex + | Opaque white |
| | | | Acetone | |
| J | 40° C. | 4.00 | Citroflex + PnB | Opaque white |

TABLE 8
Continued Stability Results of Formulations A-O. “Stable”
indicates that the formulation remains in a single-phase.

| Formula | Freeze/Thaw Stable¹ | 4° C. Stable² | RT Stable³ |
|---|---|---|---|
| N | Not Tested | Not Tested | Not Tested |
| I | Yes | Yes | Yes |
| D | No | No | No |
| G | Yes | Borderline | Yes |
| B | No | No | No |
| C | Yes | Yes | Yes |
| O | Not Tested | Not Tested | Not Tested |
| A | Yes | Yes | Yes |
| E | Yes | Yes | Yes |
| L | No | N/A | No |
| F | No | N/A | No |
| M | No | N/A | No |
| H | Yes | Yes | Yes |
| K | No | N/A | Yes |
| J | N/A | N/A | N/A |

¹Three cycles of conditioning in freezer then thawing under ambient conditions for at least 24 hours each.
²Three cycles of 4° C. conditioning then ambient conditioning for at least 24 hours each.
³Monitored for three months at room temperature/ambient conditions.

### Example 3

Preliminary testing of the formulations effect on pests was also performed. Here, a round of testing was done on samples that remained single phase through freeze thaw testing and were at least single phase for over one month. Samples were tested on mosquitoes, house flies, German roaches, and American roaches. All formulas tested had 0.075% pyrethrum and 0.45% PBO, except for Formulation L, which had 0.5% pyrethrum and 3% PBO. Rather, the samples differed in regard to the solvent and surfactants used.

### Equipment

This testing utilized insect cages, stopwatches, a fume hood to conduct fly and mosquito testing, a wooden platform with paper to renew a surface after each roach test, and plywood planks for roach testing.

### Procedure

In this example, Formulations A, C, E, I, K, L, and N were tested, and all trigger prototypes were tested on mosquitoes, flies, German roaches, and American roaches. Further, triggers were pumped 2×s for each efficacy test and the average dosage per trigger was about two grams. Formulation C, however, had an elevated level of surfactant and had a lower output of about 1.5 grams. For each test, mosquitoes and flies were placed in cages and ten of each insect were tested. Additionally, roaches were placed on a plywood platform with a plastic ring to cage the roaches. Then, the product was sprayed, and the plastic ring was lifted to allow roaches to move freely to see and observe their behavior. The insect knock down was tested for up to 60 seconds, and if bugs did not all knock down after 60 seconds the experiment was stopped, and the formulation was deemed not viable.

### Preliminary Efficacy Test Results

The results of this testing are shown in Table 9 below. Overall, from the first round of efficacy testing, all samples showed promising results for flies and mosquitoes. All samples had 100% kill at 24 hours for both insects. For German roaches, the sample that performed the best was Formulation L, which had the highest ratio of PBO to pyrethrum. This sample had 50% KD German roaches at 1 min. Second to that was Formulation N, which was a true microemulsion and was clear. These results lead to the conclusion that a microemulsion would lead to better efficacy. None of the samples were observed and recorded for more than 1 minute on German roaches. When testing on American roaches no KD was observed for any of the samples during the 60-second testing period.

TABLE 9
Summary of preliminary efficacy of formulations on flying
insects. The average spray output was 2 g/s. Formulation
C had about 1.5 g/s due to the viscosity of the formulation.

| | | | | Mosquitoes | | Flies | |
|---|---|---|---|---|---|---|---|
| | | | | 100% | | 100% | |
| | PBO/ | Surfactant/ | | KD Time | 24 hr | KD Time | 24 hr |
| Formula | Py | Oil | Solvent | (sec) | Mortality | (sec) | Mortality |
| A | 6 | 5.72 | Acetone | >5 | 100% | >60 | 100% |
| C | 6 | 17.14 | Acetone | >5 | 100% | >60 | 100% |
| E | 6 | 5.71 | Acetone | <5 | 100% | 45 | 100% |
| L | 6 | 0.86 | Acetone | >5 | 100% | 50 | 100% |
| K | 6 | 5.71 | Citroflex + | <5 | 100% | >60 | 100% |
| | | | Acetone | | | | |
| I | 6 | 12.00 | PnB | <5 | 100% | 20 | 100% |
| N | 4 | 16.80 | PnB | <5 | 100% | 30 | 100% |

| | | | | |
|---|---|---|---|---|
| O | 3 | 10.00 | Acetone | Not tested |
| H | 6 | 5.71 | Citroflex | Not tested |
| J | 6 | 4.00 | Citroflex + | Not tested |
| | | | PnB | |
| B | 6 | 4.00 | PnB | Not tested |
| D | 6 | 12.00 | PnB | Not tested |
| F | 6 | 5.71 | PnB | Not tested |
| G | 6 | 5.71 | PnB | Not tested |
| M | 6 | 1.80 | PnB | Not tested |

TABLE 10
Summary of preliminary efficacy of formulations on crawling insects.
The average spray output was 2 g/s. Formulation C had about 1.5
g/s due to the viscosity of the formulation. Roach testing was performed
on plywood, which absorbed the most amount of product.

| | | | | German Cockroaches | | American Cockroaches | |
|---|---|---|---|---|---|---|---|
| | PBO/ | Surfactant/ | | 1 min | 24 hr | 1 min | 24 hr |
| Formula | Py | Oil | Solvent | KD | Mortality | KD | Mortality* |
| A | 6 | 5.72 | Acetone | 20% | N/A | 0% | N/A |
| C | 6 | 17.14 | Acetone | 10% | N/A | 0% | N/A |
| E | 6 | 5.71 | Acetone | 20% | N/A | 0% | N/A |
| L | 6 | 0.86 | Acetone | 50% | N/A | 0% | N/A |
| K | 6 | 5.71 | Citroflex + | 20% | N/A | 0% | N/A |
| | | | Acetone | | | | |
| I | 6 | 12.00 | PnB | 0% | N/A | 0% | N/A |
| N | 4 | 16.80 | PnB | 40% | N/A | 0% | N/A |

| | | | | |
|---|---|---|---|---|
| O | 3 | 10.00 | Acetone | Not tested |
| H | 6 | 5.71 | Citroflex | Not tested |
| J | 6 | 4.00 | Citroflex + | Not tested |
| | | | PnB | |
| B | 6 | 4.00 | PnB | Not tested |
| D | 6 | 12.00 | PnB | Not tested |
| F | 6 | 5.71 | PnB | Not tested |
| G | 6 | 5.71 | PnB | Not tested |
| M | 6 | 1.80 | PnB | Not tested |

*Did not observe for 24 hours due to low knockdown.

### Example 4

A second round of efficacy testing was done on new samples with varying amounts of pyrethrum and PBO. Acetone and PNB samples were made in both trigger and aerosol form. The Acetone samples used Tween-80 and Span-80 as the surfactant. PNB samples used hydrogenated castor oil and ethoxylated linear alcohol #9 as surfactants. The desirable ratio of PBO:Py was believed to be from 3-10; thus, only ratios within this range were selected for the design of experiments.

The following requirements were used in the design of experiments: (1) Pyrethrum percentage: 0.075%-1%; (2) PBO percentage: 0.45% to 5%; (3) Solvent percentage: about 5%; (4) PBO: Py=3-10; and (5) Aqueous Intermediate for Aerosols or Water for Triggers: 82-91%. ‘Aqueous intermediate’ refers to the aqueous components, including water, corrosion inhibitors, and/or pH adjusters.

The amount of surfactant in the PNB and acetone formulations did not change with the amount of pyrethrum and PBO, thus many of the samples were not single phase over time. All the samples at least were single phase for a period after shaking, so all samples were shaken before spraying for efficacy testing.

The aerosol samples were made with 52×195 mm 16.2 bar lined cans. Further, this round of efficacy testing was only done on house flies and German roaches. It can be assumed that formulas that worked on house flies will work on mosquitoes. The formulations used during this testing are shown in Tables 11-13 below.

All aerosol formulations are filled with nitrogen to about 100 psi. Aerosol formulations are formulated with an aqueous intermediate. The aqueous intermediate includes corrosion inhibitors. The aqueous intermediate includes, 99.10 wt. % purified water, 0.36 wt. % anhydrous disodium phosphate, 0.36 wt. % potassium dihydrogen phosphate, and 0.18 wt. % ammonium hydroxide (30% ammonia).

TABLE 11
Formulations for testing: Acetone trigger and aerosol formulations.

| | Acetone Trigger & Aerosol Formulas | | | |
|---|---|---|---|---|
| Material | Ace-1 | Ace-2 | Ace-3 | Ace-4 |
| Acetone | 5.00 | 5.00 | 5.00 | 5.00 |
| Pyrethrum, 50% | 1.00 | 1.67 | 1.00 | 0.15 |
| Piperonyl Butoxide | 3.00 | 5.00 | 5.00 | 0.45 |
| Span 80 | 1.40 | 1.40 | 1.40 | 1.40 |
| Tween 80 | 1.60 | 1.60 | 1.60 | 1.60 |
| Water/Aqueous Intermediate | 88.00 | 85.33 | 86.00 | 91.40 |
| Surfactant:Oil | 0.86 | 0.51 | 0.55 | 5.71 |
| PBO:Py | 6 | 6 | 10 | 6 |

TABLE 12
Formulations for testing: Propylene glycol n-butyl
ether (PnB) trigger and aerosol formulations.

| | PnB Trigger & Aerosol Formulas | | | |
|---|---|---|---|---|
| Material | PnB-1 | PnB-2 | PnB-3 | PnB-4 |
| Propylene Glycol n-Butyl Ether | 5.00 | 5.00 | 5.00 | 5.00 |
| Pyrethrum, 50% | 1.00 | 1.67 | 0.50 | 0.15 |
| Piperonyl Butoxide | 3.00 | 5.00 | 2.50 | 0.45 |
| Hydrogrenated Castor Oil | 4.20 | 4.20 | 4.20 | 4.20 |
| Secondary Alcohol | 2.10 | 2.10 | 2.10 | 2.10 |
| Ethoxylate, 9EO | | | | |
| Water/Aqueous Intermediate | 84.70 | 82.03 | 85.70 | 88.10 |
| Surfactant:Oil | 1.80 | 1.08 | 2.29 | 12.00 |
| PBO:Py | 6 | 6 | 10 | 6 |

TABLE 13
Formulations for Testing: Petroleum distillates
(D80) and C₁₁-C₁₃ hydrocarbons.

D80 & Isopar Formulas

| Material | D80-1 | Iso-1 |
|---|---|---|
| Petroleum distillates (D80) | 5.00 | — |
| C11-13 Hydrocarbons (Isopar L) | — | 5.00 |
| Pyrethrum, 50% | 1.00 | 1.00 |
| Piperonyl Butoxide | 3.00 | 3.00 |
| Span 80 | 1.40 | 1.40 |
| Tween 80 | 1.60 | 1.60 |
| Water/Aqueous Intermediate | 88.00 | 88.00 |
| Surfactant:Oil | 0.86 | 0.86 |
| PBO:Py | 6 | 6 |

### Experimental Procedure

The experiments were performed according to the following procedure. First, triggers were pumped 2 times for each efficacy test (about 2 grams per test). Further, aerosols were sprayed 2 seconds for each efficacy test (˜2.5 grams per test). Flies were places in a cage and ten of each insect were tested. Roaches were placed in a cage for direct spraying, and then placed onto a platform to move freely to observe their behavior. KD was observed until 100% KD for both German roaches and house flies. Roaches and house flies were kept for 24-hour observation to determine if they were all killed within that time span.

### Test Results

The results from this testing is shown in Tables 14-17 below.

TABLE 14
Results from testing: trigger formulations tested
on flies for knockdown (KD) and mortality.

Flies

| Trigger | Time to 90-100% | Mortality % |
|---|---|---|
| Formula | KD (sec) | at 24 hr |
| Ace-1 | >60 (50% at 30 sec) | 100 |
| Ace-2 | Not tested | Not tested |
| Ace-3 | 40 | 100 |
| Ace-4 | 45 | 100 |
| D80-1 | 30 | 100 |
| Iso-1 | 40 | 100 |
| PnB-1 | 20 | 100 |
| PnB-2 | 30 | 100 |
| PnB-3 | 15 | 100 |
| PnB-4 | 20 | 100 |

TABLE 15
Results from testing trigger formulations on German cockroaches
for knockdown (KD) and mortality. NT = Not Tested.

| | German Cockroaches | | | | | |
|---|---|---|---|---|---|---|
| Trigger | 30 sec | 1 min | 3 min | 4 min | 10 min | Mortality |
| Formula | KD % | KD % | KD % | KD % | KD % | % at 24 hr |
| Ace-1 | NT | NT | NT | NT | NT | NT |
| Ace-2 | 30 | 60 | NT | NT | 100 | 100 |
| Ace-3 | 40 | NT | 70 | 100 | NT | 100 |
| Ace-4 | NT | 20 | NT | NT | 100 | NT |
| D80-1 | NT | NT | NT | NT | NT | NT |
| Iso-1 | NT | NT | NT | NT | NT | NT |
| PnB-1 | NT | 70 | NT | NT | 100 | NT |
| PnB-2 | NT | 30 | NT | NT | NT | 90 |
| PnB-3 | 50 | 80 | NT | 100 | NT | 100 |
| PnB-4 | 10 | 50 | NT | NT | 100 | 100 |

TABLE 16
Results from testing aerosol formulations
on flies for knockdown (KD) and mortality.

Flies

| Aerosol | Time to 90-100% | Mortality % |
|---|---|---|
| Formula | KD (sec) | at 24 hr |
| Ace-1 | 60 | 100 |
| Ace-2 | 45 | 100 |
| Ace-3 | Not Tested | Not Tested |
| Ace-4 | Not Tested | Not Tested |
| D80-1 | 60 | 100 |
| Iso-1 | 60 | 100 |
| PnB-1 | 20 | Not Tested |
| PnB-2 | 23 | Not Tested |
| PnB-3 | 16 | Not Tested |
| PnB-4 | 60 | Not Tested |

TABLE 17
Results from testing aerosol formulations on German
cockroaches for knockdown (KD) and mortality.

| | German Cockroaches | | | | |
|---|---|---|---|---|---|
| Aerosol | 30 sec | 1 min | 10 min | 20 min | Mortality % |
| Formula | KD % | KD % | KD % | KD % | at 24 hr |
| Ace-1 | NT | 10 | 100 | NT | 90 |
| Ace-2 | NT | 20 | 100 | NT | NT |
| Ace-3 | NT | NT | NT | NT | NT |
| Ace-4 | NT | NT | NT | NT | NT |
| D80-1 | NT | 20 | 100 | NT | 100 |
| Iso-1 | NT | 20 | 100 | NT | 90 |
| PnB-1 | 40 | 60 | 100 | NT | 100 |
| PnB-2 | 20 | NT | 100 | NT | 100 |
| PnB-3 | 70 | NT | NT | 100 | 90 |
| PnB-4 | 20 | NT | 100 | NT | 60 |

NT = Not Tested.

From the second round of efficacy testing, all samples showed promising results for house flies. All samples had 100% kill at 24 hours for house flies.

Between all the samples, PnB-4 had the fastest roach knock down and the fastest fly knock down. In fact, PnB-4 had the highest ratio of PBO:Py in the design of experiment. This sample had 10×s as much PBO as pyrethrum in the formula. Notably, the percent pyrethrum was not the highest, nor was the % PBO the highest of the experiment. This shows the ratio of PBO had a more impactful effect on roach knock down than the actual % active or % PBO. Further, the PnB-4 sample used PNB as the solvent.

Sample Ace-3 had the next fastest fly knock down. The Ace-3 sample actually had the highest ratio of PBO:Py in the design of experiment at 10×s the amount of PBO:Py. Like sample PnB-4, Ace-3 did not have the highest amount of pyrethrum in the experiment. However, unlike PnB-4, this sample did have the highest total % PBO of all the formulas.

### Example 5

A series of additional formulations were prepared and used in trigger testing for knock down and mortality.

### Formulation Preparation

The water/aqueous intermediate is prepared by adding the water, preservative, corrosion inhibitor, and any other water-soluble materials to a container and mixed at room temperature until all ingredients are in solution and evenly dispersed. It is then covered until needed to make the finished product. This aqueous intermediate will be warmed to 40° C. before adding it to the active intermediate.

The oil/active intermediate is prepared by adding the solvents, surfactants, active ingredients, fragrance (if used), and any other oil soluble materials to a container while warming to 40° C. The intermediate is mixed until all ingredients are in solution and evenly dispersed.

With both intermediates at 40° C., the water intermediate is slowly added to the oil intermediate with mixing. The mixing is continued until all ingredients are evenly dispersed. The resulting product is then place into a coverable container and allowed to return to room temperature for evaluation.

TABLE 18
Example Microemulsions: Py/PBO Phase Liquid

| | 23-1 | 23-2 | 23-3 | 23-4 | 23-5 | 23-6 |
|---|---|---|---|---|---|---|
| Water DI | 90.3500 | 87.3500 | 88.4000 | 91.4000 | 88.4000 | 88.4000 |
| Potassium | 0.1000 | 0.1000 | 0.1000 | 0.1000 | 0.1000 | 0.1000 |
| Sorbate | | | | | | |
| Ammonium | 0.2000 | 0.2000 | 0.2000 | 0.2000 | 0.2000 | 0.2000 |
| Benzoate | | | | | | |
| Alcohol | | 3.0000 | 3.0000 | | | |
| TPM Glycol | 3.0000 | 3.0000 | 3.0000 | 3.0000 | 3.0000 | 3.0000 |
| Black Pepper | | | | | | 3.0000 |
| Oil | | | | | | |
| Parsley Oil | | | | | 3.0000 | |
| Sasol Novel | 1.6000 | 1.6000 | 1.6000 | 1.6000 | 1.6000 | 1.6000 |
| 810-4 | | | | | | |
| Castor Oil 60 | 3.2000 | 3.2000 | 3.2000 | 3.2000 | 3.2000 | 3.2000 |
| Ethoxylate | | | | | | |
| Pyrethrum 50% | 0.5000 | 0.5000 | 0.5000 | 0.5000 | 0.5000 | 0.5000 |
| PBO | 1.0500 | 1.0500 | | | | |
| Total | 100.0000 | 100.0000 | 100.0000 | 100.0000 | 100.0000 | 100.0000 |

### Experimental Procedure and Testing

The experiments were performed according to the following procedure. First, triggers were pumped for a specified number of times for each efficacy test (as indicated in the following Tables). Roaches were placed in a cage for direct spraying, and then placed onto a platform to move freely to observe their behavior. KD was observed until 100% KD for German roaches. Roaches were kept for 24-hour observation to determine if they were all killed within that time span.

TABLE 19
Mean % Knocked Down and Mortality for Direct Spray of
German Roach, 3 Trigger Pulls, 18″ Spray, Screen Method

| | | | | | | | | Mean % | Mean |
|---|---|---|---|---|---|---|---|---|---|
| | Mean % Knock Down | | | | | | | mortality | discharge rate |
| Formulation | 20 s | 30 s | 1 min | 3 min | 5 min | 1 h | 2 h | 24 h | g |
| 23-1 | 22 | 30 | 26 | 76 | 100 | 100 | 100 | 100 | 2.91 |
| 23-2 | 16 | 20 | 28 | 52 | 98 | 100 | 100 | 100 | 2.71 |
| 23-3 | 22 | 36 | 34 | 68 | 100 | 100 | 100 | 100 | 2.72 |
| 23-4 | 22 | 24 | 14 | 66 | 100 | 100 | 100 | 100 | 2.78 |
| 23-5 | 14 | 24 | 30 | 66 | 100 | 100 | 100 | 100 | 2.61 |
| 23-6 | 16 | 28 | 40 | 42 | 100 | 100 | 100 | 100 | 2.71 |
| untreated | n/a | n/a | n/a | n/a | n/a | n/a | n/a | 0 | n/a |
| controls | | | | | | | | | |
| untreated | n/a | n/a | n/a | n/a | n/a | n/a | n/a | 0 | n/a |
| controls | | | | | | | | | |

TABLE 20
Mean % Knocked Down and Mortality for Direct Spray of American
Roach, 4 Trigger Pulls, 18″ Spray, Screen Method

| | | | | | | | | | | Mean |
|---|---|---|---|---|---|---|---|---|---|---|
| | Mean % Knock Down | | | | | | | Mean % mortality | | discharge rate |
| Formulation | 20 s | 30 s | 1 min | 3 min | 5 min | 1 h | 2 h | 24 h | 48 h | g |
| 23-1 | 0 | 0 | 0 | 68 | 100 | 100 | 100 | 84 | 100 | 3.71 |
| 23-2 | 0 | 0 | 0 | 56 | 96 | 100 | 100 | 92 | 100 | 3.69 |
| 23-3 | 0 | 0 | 16 | 84 | 100 | 100 | 100 | 64 | 100 | 3.58 |
| 23-4 | 0 | 4 | 20 | 88 | 100 | 100 | 100 | 60 | 100 | 3.80 |
| 23-5 | 0 | 0 | 8 | 56 | 88 | 100 | 100 | 40 | 96 | 3.60 |
| 23-6 | 0 | 0 | 12 | 56 | 100 | 100 | 100 | 60 | 96 | 3.70 |
| untreated | n/a | n/a | n/a | n/a | n/a | n/a | n/a | 0 | 0 | n/a |
| controls | | | | | | | | | | |

### Example 6

A series of additional formulations were prepared and used in trigger testing for knock down and mortality.

### Formulation Preparation

The water/aqueous intermediate is prepared by adding the water, preservative, corrosion inhibitor, and any other water-soluble materials to a container and mixed at room temperature until all ingredients are in solution and evenly dispersed. It is then covered until needed to make the finished product. This aqueous intermediate will be warmed to 40° C. before adding it to the active intermediate.

The oil/active intermediate is prepared by adding the solvents, surfactants, active ingredients, fragrance (if used), and any other oil soluble materials to a container while warming to 40° C. The intermediate is mixed until all ingredients are in solution and evenly dispersed.

With both intermediates at 40° C., the water intermediate is slowly added to the oil intermediate with mixing. The mixing is continued until all ingredients are evenly dispersed. The resulting product is then place into a coverable container and allowed to return to room temperature for evaluation.

TABLE 21
Micro Emulsion Py/PBO One Phase Liquid

| | 19-1 | 19-2 | 19-3 | 19-4 | 19-5 |
|---|---|---|---|---|---|
| Water DI | 94.150 | 92.150 | 88.150 | 89.450 | 86.150 |
| Potassium Sorbate | 0.100 | 0.100 | 0.100 | 0.100 | 0.100 |
| Ammonium Benzoate | 0.200 | 0.200 | 0.200 | 0.200 | 0.200 |
| TPM Glycol | — | 2.000 | 6.000 | 6.000 | 6.000 |
| Sasol Novel 810-4 ETO | 2.500 | 2.500 | 2.500 | 1.900 | 3.700 |
| Castor Oil 60 Ethoxylate | 1.500 | 1.500 | 1.500 | 0.800 | 2.300 |
| Pyrethrum 50% | 0.500 | 0.500 | 0.500 | 0.500 | 0.500 |
| PBO | 1.050 | 1.050 | 1.050 | 1.050 | 1.050 |
| Total | 100.000 | 100.000 | 100.000 | 100.000 | 100.000 |
| After Making with | Clear | Clear | Clear | Opaque | Clear |
| Shaking | | | | | |
| After 24 Hours no | Clear | Clear | Clear | Opaque | Clear |
| Shaking | | | | | |
| Results recorded | | | | | |
| 24 hr. after returning | | | | | |
| to RT ~70° F. | | | | | |
| After Freeze/Thaw Cycle | Clear | Clear | Clear | Opaque | Clear |
| (10° F./−12° C.) | | | | | |
| After 130° F. 24 hr | Clear | Clear | Clear | Opaque | Clear |
| Storage | | | | | |

### Experimental Procedure and Testing

The experiments were performed according to the following procedure. First, triggers were pumped for a specified number of times for each efficacy test (as indicated in the following Tables). Roaches were placed in a cage for direct spraying, and then placed onto a platform to move freely to observe their behavior. KD was observed until 100% KD for German roaches. Roaches were kept for 24-hour observation to determine if they were all killed within that time span.

The following samples were a tested against German and American roaches shows the high level of performance that can be obtained with clear, reverse micro-emulsions. These samples show the consistency of the system even when varying the ratios of glycol to surfactant in the system that still produced clear product in most cases.

TABLE 22
Mean % Knocked Down Mortality Results for Direct Spray of
German Roach, 3 Trigger Pulls, 18″ Spray, Screen Method

| | | | | | | | | Mean % | Mean |
|---|---|---|---|---|---|---|---|---|---|
| | Mean % Knock Down | | | | | | | mortality | discharge |
| Formulation | 20 s | 30 s | 1 min | 3 min | 5 min | 1 h | 2 h | 24 h | g |
| 19-1 | 0 | 18 | 36 | 98 | 100 | 100 | 100 | 100 | 2.78 |
| 19-2 | 18 | 20 | 26 | 96 | 100 | 100 | 100 | 100 | 2.87 |
| 19-3 | 12 | 28 | 26 | 98 | 100 | 100 | 100 | 100 | 2.79 |
| 19-4 | 12 | 16 | 20 | 90 | 100 | 100 | 100 | 100 | 2.82 |
| 19-5 | 8 | 20 | 26 | 88 | 100 | 100 | 100 | 100 | 2.77 |
| untreated | n/a | n/a | n/a | n/a | n/a | n/a | n/a | 0 | n/a |
| controls | | | | | | | | | |

TABLE 23
Mean % Knocked Down Mortality Results for Direct Spray of
American Roach, 4 Trigger Pulls, 18″ Spray, Screen Method

| | | | | | | | | Mean % | Mean |
|---|---|---|---|---|---|---|---|---|---|
| | Mean % Knock Down | | | | | | | mortality | discharge |
| sample ID | 20 s | 30 s | 1 min | 3 min | 5 min | 1 h | 2 h | 24 h | g |
| 19-1 | 0 | 4 | 24 | 72 | 100 | 100 | 100 | 92 | 3.62 |
| 19-2 | 0 | 4 | 52 | 96 | 100 | 100 | 100 | 96 | 3.7 |
| 19-3 | 0 | 4 | 36 | 88 | 100 | 100 | 100 | 100 | 3.7 |
| 19-4 | 0 | 0 | 24 | 80 | 100 | 100 | 100 | 96 | 3.6 |
| 19-5 | 0 | 0 | 8 | 88 | 100 | 100 | 100 | 92 | 3.65 |
| untreated | na | na | na | na | na | na | na | 0 | n/a |
| controls | | | | | | | | | |

### Example 7

This example describes a type of pyrethroid formulation that shows very good roach activity when tested on both American and German roaches. This formulation was prepared and used in trigger pump testing for knock down and mortality.

Formula 32-8 is provided below in Table 24 and was made in the same manner as the formulations in Examples 5 and 6. Formula 32-8 and similar formulations have potential for faster knockdown and can provide a longer residual life.

TABLE 24
One Phase Example Formulation

| | Formulation 32-8 |
|---|---|
| Water | 89.384 |
| Ammonium Benzoate | 0.2 |
| TPM Glycol | 6 |
| Novel 810-4 | 2.5 |
| Castor Oil 60 Ethoxylate | 1.5 |
| Imiprothrin 50.5% | 0.198 |
| Prallethrin 92% | 0.109 |
| Cypermethrin 92% | 0.109 |
| Total | 100 |
| After Making with Shaking | Clear |
| After 24 Hours no Shaking | Clear |
| Results recorded 24 hr. after | |
| returning to RT ~70 F. | |
| After Freeze/Thaw Cycle | Clear |
| (10 F./−12 C.) | |
| After 130 F. 24 hr Storage | Clear |

Table 25 below shows the trigger pump knockdown and mortality results for the 32-8 formulation. These tests were conducted as described above with respect to Examples 5 and 6.

TABLE 25
Knockdown and Mortality Results for Formulation 32-8

| Mean % Knockdown | | | | | | | Mortality | | |
|---|---|---|---|---|---|---|---|---|---|
| 20 | 30 | 1 | 3 | 5 | 1 | 2 | 24 | 48 | Dose |
| sec | sec | min | min | min | hr | hr | hr | hr | grams |

Mean % Knocked Down and Mean % Mortality Results
for Direct Spray American roach - 2 Pull from 18″

| | | | | | | | | | | |
|---|---|---|---|---|---|---|---|---|---|---|
| 32-8 | 12 | 32 | 72 | 100 | 100 | 100 | 100 | 56 | 100 | 1.89 |
| Untreated | n/a | n/a | n/a | n/a | n/a | n/a | n/a | 0 | 0 | n/a |
| Control | | | | | | | | | | |

Mean % Knocked Down and Mean % Mortality Results
for Direct Spray German roach - 2 Pull from 18″

| | | | | | | | | | | |
|---|---|---|---|---|---|---|---|---|---|---|
| 32-8 | 22 | 28 | 80 | 100 | 100 | 100 | 100 | 100 | 100 | 1.77 |
| Untreated | n/a | n/a | n/a | n/a | n/a | n/a | n/a | 0 | 0 | n/a |
| Control | | | | | | | | | | |

### Example 8

This example describes formulas that did not result in stable, non-separating micro-emulsions/reverse emulsions. These formulas indicate the need for researching and selecting surfactant/surfactant blends and solvents that combined with the active ingredients will produce a stable system. It is critical to know the hydrophilic-lipophilic balance (HLB), solubility parameters, hydrophile-lipophile properties, surface tension, etc. of the ingredients to successfully produce stable systems. These formulas also show the need to actually put the formulas together to evaluate the theoretical data.

The formulations in this example were made in a similar way to that described above with reference to Examples 5 and 6.

TABLE 26
Micro Emulsion Py/PBO Phase Liquid Formulations

| | 24-1 | 24-2 | 24-3 | 24-4 | 24-5 |
|---|---|---|---|---|---|
| Water DI | 87.1500 | 82.1500 | 77.1500 | 81.1500 | 87.1500 |
| Potassium Sorbate | 0.1000 | 0.1000 | 0.1000 | 0.1000 | 0.1000 |
| Ammonium Benzoate | 0.2000 | 0.2000 | 0.2000 | 0.2000 | 0.2000 |
| TPM Glycol | 6.0000 | 6.0000 | 6.0000 | 12.0000 | 6.0000 |
| Isopropyl alcohol | 0.0000 | 5.0000 | 10.0000 | | |
| Tween 80 | 5.0000 | 5.0000 | 5.0000 | 5.0000 | 4.0000 |
| Sasol Novel 810-4 ETO | | | | | 1.0000 |
| Pyrethrum 50% | 0.5000 | 0.5000 | 0.5000 | 0.5000 | 0.5000 |
| PBO | 1.0500 | 1.0500 | 1.0500 | 1.0500 | 1.0500 |
| Total | 100.0000 | 100.0000 | 100.0000 | 100.0000 | 100.0000 |
| Appearance | | | | | |
| After Making with Shaking | Opaque | Opaque | Opaque | Opaque | Opaque |
| Foam Level after Shaking | Low | Low | Low | Low | Low |
| After 24 Hours no Shaking | Separated | Separated | Separated | Separated | Separated |
| | Terminate | Terminate | Terminate | Terminate | Terminate |

All of the above formulas were opaque upon completion of adding all ingredients and mixing. They initially were one phase, but over 24 hours separated and were deemed not acceptable.

TABLE 27
Micro Emulsion Py/PBO Phase Liquid

| | 28-1 | 28-2 | 28-3 | 28-4 | 28-5 | 28-6 |
|---|---|---|---|---|---|---|
| Water DI | 90.050 | 90.050 | 93.050 | 93.050 | 88.150 | 91.150 |
| Potassium Sorbate | 0.100 | 0.100 | 0.100 | 0.100 | 0.100 | 0.100 |
| Ammonium | 0.200 | 0.200 | 0.200 | 0.200 | 0.200 | 0.200 |
| Benzoate | | | | | | |
| TPM Glycol | 6.000 | — | 3.000 | — | 6.000 | 3.000 |
| PnB Glycol | — | 6.000 | — | 3.000 | — | — |
| Ethoxylated Linear | 0.700 | 0.700 | 0.700 | 0.700 | — | — |
| Alcohol 9 | | | | | | |
| Sasol Novel 810-4 | — | — | — | — | 2.500 | 2.500 |
| ETO | | | | | | |
| Hydrogenated | 1.400 | 1.400 | 1.400 | 1.400 | 1.500 | 1.500 |
| Castor Oil 60 | | | | | | |
| Ethoxylate | | | | | | |
| Pyrethrum 50% | 0.500 | 0.500 | 0.500 | 0.500 | 0.500 | 0.500 |
| PBO | 1.050 | 1.050 | 1.050 | 1.050 | 1.050 | 1.050 |
| Total | 100.000 | 100.000 | 100.000 | 100.000 | 100.000 | 100.000 |
| After Making with | Opaque | Opaque | Opaque | Opaque | Clear | Clear |
| Shaking | | | | | | |
| After 24 Hours no | Opaque | Opaque | Opaque | Opaque | Clear | Clear |
| Shaking | | | | | | |
| Results recorded 24 hr. after | | | | | | |
| returning to RT ~70° F. | | | | | | |
| After Freeze/Thaw | S | S | S | S | Clear | Clear |
| Cycle (10° F./−12° C.) | | | | | | |
| After 130° F. 24 hr | Terminate | Terminate | Terminate | Terminate | Clear | Clear |
| Storage | | | | | | |

The above Table 27 represents formulas with surfactant blends that produced stable formulas when used with pyrethroids but needed to be modified to work well with natural Pyrethrum and piperonyl butoxide. What works with one set of materials may not be something that has broad spectrum application. However, it is also noted that the system that produced a stable system in formulas 5 and 6 above, also produced a stable system when used with pyrethroids as seen in table 24 above.

### Example 9

This example shows the difference in roach knockdown and kill of a single-phase reverse emulsion/micro-emulsion (32-1) and a water-out macro-emulsion (32-4). As can be seen from this data the micro-emulsion has faster insect knockdown and a slight improvement in mortality. Both formulas have the same level of insecticide and solvent. The surfactants and their level are the only differences. The formulations were made and the tests were conducted as described above with respect to Examples 5 and 6. The formulations and testing data are described in Tables 28 and 29 below.

TABLE 28
Micro Emulsion Py/PBO Phase Liquid

| | 32-1 | 32-4 |
|---|---|---|
| Water DI | 88.2500 | 90.9500 |
| Ammonium Benzoate | 0.2000 | 0.2000 |
| TPM Glycol | 6.0000 | 6.0000 |
| Sasol Novel 810-4 ETO | 2.5000 | |
| Hydrogenated Castor Oil 60 Ethoxylate | 1.5000 | 1.0000 |
| Pyrethrum 50% | 0.5000 | 0.5000 |
| PBO | 1.0500 | 1.0500 |
| Glycerol Monooleate | | 0.3000 |
| Total | 100.0000 | 100.0000 |

TABLE 29
Knockdown and mortality results for the formulations of Table 28

| Mean % Knock Down | | | | | Mean % mortality | | |
|---|---|---|---|---|---|---|---|
| 30 | 1 | 3 | 5 | 1 | 24 | 48 | Dosage |
| sec | min | min | min | hour | hr | hr | g |

Mean % Knocked Down and Mean % Mortality Results for
Direct Spray of American Roaches at 18″ Screen Method

| | | | | | | | | |
|---|---|---|---|---|---|---|---|---|
| 32-1 | 0 | 8 | 52 | 96 | 100 | 80 | 100 | 1.83 |
| 32-4 | 0 | 0 | 20 | 72 | 100 | 68 | 100 | 2.03 |

Mean % Knocked Down and Mean % Mortality Results for
Direct Spray of German Roaches at 18″ Screen Method.

| | | | | | | | | |
|---|---|---|---|---|---|---|---|---|
| 32-1 | 8 | 12 | 76 | 100 | 100 | 100 | 100 | 1.85 |
| 32-4 | 2 | 18 | 54 | 90 | 100 | 100 | 100 | 1.83 |

TABLE 30
Component ranges for example formulations

| | Lower | Upper | Example |
|---|---|---|---|
| | Level | level | formulation |
| Solvent (glycol, alcohol or other) | 0.00 | 12.00 | 6.0 |
| Surfactant 1 | 0.50 | 8.00 | 2.5 |
| Surfactant 2 (if used) | 0.50 | 6.00 | 1.5 |
| Corrosion inhibitors (if used) | 0.05 | 0.40 | 0.2 |
| Preservatives (if used) | 0.05 | 0.40 | |
| Pryrethrum (if used) | 0.10 | 1.00 | 0.5 |
| One of more Pyrethroids (if used) | 0.05 | 0.50 | |
| Synergists (if used) | 0.15 | 4.00 | 1.05 |
| Water | 98.60 | 67.70 | 88.25 |
| Total | 100.00 | 100.00 | 100.00 |

### Example 10

Several formulations will be tested to showcase their stability. For example, one or more formulations according to that outlined in Table 31 below will be formulated and will be observed to determine whether residue formed. In particular, various solvents will be tested, including acetone, propylene glycol n-butyl ether, tri propylene glycol mono methyl ether, and citroflex. Then the relevant and/or optimal surfactants for each solvent will be determined. It is expected that for Tri propylene glycol mono methyl ether, the optimal and/or relevant surfactants include hydrogenated castor oil and ALFONIC 810-4.5 Alcohol Ethoxylate or ethoxylated linear alcohol #9. The results for propylene glycol n-butyl ether, acetone, and Citroflex® are discussed above in Example 1.

TABLE 31
Outline of water-based, single phase pest control compositions.

| Component | Ingredient Options | Weight % |
|---|---|---|
| Water | Purified Water | q.s. |
| Solvent | Propylene Glycol n-Butyl Ether (PnB) | 2-12 |
| | Acetyltri-n-butyl citrate (Citroflex) | |
| | Acetone with at least 20% water | |
| | solubility or other glycol with at | |
| | least 20% water solubility or alcohol | |
| | with at least 20% water solubility. | |
| Surfactant 1 | Hydrogenated Castor Oil | 1.0-6.0 |
| | Span 80 (sorbitan monooleate) | |
| | ALFONIC 810-4.5 | |
| | Alcohol Ethoxylate | |
| Surfactant 2 | Secondary Alcohol Ethoxylate, 9EO | 0.5-6.0 |
| | Tween 80 (polyoxyethylene | |
| | sorbitan monooleate) | |
| | Polyethylene glycol stearate | |
| Active | Natural Pyrethrum | 0.075-0.50 |
| Ingredient | | |
| Synergist | Piperonyl Butoxide (PBO) | 0.3-3.0 |
| Propellant | Nitrogen | filled to |
| (aerosol only) | | 100-120 psi |

### Example 11

This example describes pyrethrum formulations that were assessed in trigger pump tested for knock down and mortality of roaches and flies.

The formulations provided below in Table 32 were made in the same manner as the formulations in Examples 5 and 6. The knock down and mortality test results are shown below in Tables 33-35. After the data on American Roaches shown in Table 33, it was determined that sample formulations 35-1, 35-2, 35-5, and 35-6 would be further tested on German Roaches and Flies.

TABLE 32
Micro Emulsion Py/PBO Phase Liquid

| | 35-1 | 35-2 | 35-3 | 35-4 | 35-5 | 35-6 |
|---|---|---|---|---|---|---|
| Water DI | 88.250 | 89.300 | 88.600 | 89.400 | 88.900 | 89.500 |
| Ammonium Benzoate | 0.200 | 0.200 | 0.200 | 0.200 | 0.200 | 0.200 |
| TPM Glycol | 6.000 | 6.000 | 6.000 | 6.000 | 6.000 | 6.000 |
| Sasol Novel 810-4 ETO | 2.500 | 2.500 | 2.500 | 2.500 | 2.500 | 2.500 |
| Hydrogenated Castor Oil 60 | 1.500 | 1.500 | 1.500 | 1.500 | 1.500 | 1.500 |
| Ethoxylate | | | | | | |
| Pyrethrum 50% | 0.500 | 0.500 | 0.400 | 0.400 | 0.300 | 0.300 |
| Piperonyl Butoxide | 1.050 | 0.000 | 0.800 | 0.000 | 0.600 | 0.000 |
| Total | 100.000 | 100.000 | 100.000 | 100.000 | 100.000 | 100.000 |

TABLE 33
Knockdown and mortality results for the formulations of Table 32 - American Roach
Mean % Knocked Down and Mean % Mortality Results for Direct
Spray of American Roach, 2 Trigger Pulls, 18″ Spray, Screen Method,

| | | | | | | | | | | Mean |
|---|---|---|---|---|---|---|---|---|---|---|
| | Mean % Knock Down | | | | | | | Mean % Mortality | | Discharge Rate |
| Sample ID | 20 s | 30 s | 1 min | 3 min | 5 min | 1 h | 2 h | 24 h | 48 h | g |
| 35-1 | 0 | 0 | 12 | 52 | 88 | 100 | 100 | 52 | 100 | 1.92 |
| 35-2 | 0 | 0 | 16 | 76 | 100 | 100 | 100 | 20 | 100 | 1.76 |
| 35-3 | 0 | 0 | 4 | 28 | 76 | 100 | 100 | 56 | 100 | 1.85 |
| 35-4 | 0 | 0 | 12 | 56 | 96 | 100 | 100 | 12 | 96 | 1.91 |
| 35-5 | 0 | 0 | 0 | 40 | 64 | 100 | 100 | 32 | 100 | 1.79 |
| 35-6 | 0 | 0 | 8 | 56 | 100 | 100 | 100 | 24 | 100 | 1.91 |
| Untreated | na | na | na | na | na | na | na | 0 | 0 | na |
| controls | | | | | | | | | | |

TABLE 34
Knockdown and mortality results for selected formulations of Table 32 - German Roach
Mean % Knocked Down and Mean % Mortality Results for Direct
Spray of German Roach, 2 Trigger Pulls, 18″ Spray, Screen Method

| | | | | | | | | | | Mean |
|---|---|---|---|---|---|---|---|---|---|---|
| | Mean % Knock Down | | | | | | | Mean % Mortality | | Discharge Rate |
| Sample ID | 20 s | 30 s | 1 min | 3 min | 5 min | 1 h | 2 h | 24 h | 48 h | g |
| 35-1 | 14 | 28 | 22 | 68 | 100 | 100 | 100 | 100 | na | 1.82 |
| 35-2 | 10 | 14 | 24 | 76 | 100 | 100 | 100 | 100 | na | 1.77 |
| 35-5 | 14 | 18 | 22 | 44 | 66 | 100 | 100 | 100 | na | 1.78 |
| 35-6 | 18 | 24 | 16 | 54 | 80 | 100 | 100 | 100 | na | 1.86 |
| Untreated | na | na | na | na | na | na | na | 0 | na | na |
| controls | | | | | | | | | | |

TABLE 35
Knockdown and mortality results for selected formulations of Table 32 - House Flies
Mean % Knocked Down and Mean % Mortality Results for Direct
Spray of House Flies, 2 Trigger Pulls, 18″ Spray, Screen Method

| | | | | | | | | | | Mean |
|---|---|---|---|---|---|---|---|---|---|---|
| | Mean % Knock Down | | | | | | | Mean % Mortality | | Discharge Rate |
| Sample ID | 20 s | 30 s | 1 min | 3 min | 5 min | 1 h | 2 h | 24 h | 48 h | g |
| 35-1 | 98 | 100 | 100 | 100 | 100 | 100 | 100 | 100 | na | 1.88 |
| 35-2 | 98 | 100 | 100 | 100 | 100 | 100 | 100 | 100 | na | 1.83 |
| 35-5 | 88 | 100 | 100 | 100 | 100 | 100 | 100 | 100 | na | 1.93 |
| 35-6 | 92 | 100 | 100 | 100 | 100 | 100 | 100 | 100 | na | 1.90 |
| Untreated | na | na | na | na | na | na | na | 6 | na | na |
| controls | | | | | | | | | | |

The present disclosure can also be described in the following numbered clauses.

Clause 1. A pest control composition, the composition comprising: at least one active ingredient; at least one non-aqueous solvent; at least one surfactant; and water.

Clause 2. The pest control composition of clause 1, further comprising a synergist, wherein the active ingredient is about 0.05 wt. % to about 1 wt. % of pyrethroid, or pyrethrum, the synergist is about 0.10% wt. % to about 5 wt. % of piperonyl butoxide, or MGK-264, the at least one non-aqueous solvent is about 2 wt. % to about 12 wt. %, the at least one surfactant is about 0.7 wt. % to about 8.0 wt. %, and the water is about 74 wt. % to about 91 wt. %, and wherein a weight ratio of piperonyl butoxide or MGK-264 to pyrethrum is between about 1:1 and about 20:1, and wherein all weight percentages are percent by weight of the total composition, and wherein the composition is a single phase.

Clause 3. The pest control composition of clause 1 or 2, wherein the at least one non-aqueous solvent is a propylene-based glycol ether, acetone, an ester of citric acid, an alcohol with at least 20% water solubility, or any combination thereof.

Clause 4. The pest control composition of clause 2, wherein the at least one surfactant comprises about 1.1 wt. % to about 8.0 wt. % of a first surfactant and about 0.7 wt. % and to about 6.0 wt. % of a second surfactant.

Clause 5. The pest control composition of clause 4, wherein the at least one surfactant comprises hydrogenated castor oil, ethoxylated linear alcohol #9, polyethylene glycol sorbitan monooleate, polyethylene glycol stearate, sorbitan monooleate, a C6-C12 ethoxylated alcohol, sodium dodecyl benzenesulfonate, alcohol ethoxylate 4.0, ethoxylated linear alcohol, glyceryl monooleate, sorbitan monopalmitate, or any combinations thereof.

Clause 6. The pest control composition of any one of clauses 1-5, wherein the pest control composition is a single phase.

Clause 7. The pest control composition of clause 5, wherein the pest control composition comprises: i) about 0.05 wt. % to about 0.5 wt. % pyrethrum and a weight ratio of piperonyl butoxide to pyrethrum is between about 1:1 and about 10:1; or ii) one or more pyrethroids in an amount of about 0.05 wt. % to about 0.4 wt. % and a weight ratio of piperonyl butoxide to the one or more pyrethroids is about 0:1 to about 5:1.

Clause 8. The pest control composition of clause 5, wherein the pest control composition comprises about 0.5 wt. % to about 3 wt. % piperonyl butoxide, and the at least one non-aqueous solvent is a propylene-based glycol ether with at least 20% water solubility or an alcohol with at least 20% water solubility.

Clause 9. The pest control composition of clause 5, wherein the pest control composition comprises about 0.1 wt. % to about 0.5 wt. % pyrethrum, about 0.5 wt. % to about 3.0 wt. % piperonyl butoxide, wherein a weight ratio of piperonyl butoxide to pyrethrum is about 1:1 to about 10:1, and wherein the at least one non-aqueous solvent is a propylene-based glycol ether with at least 20% water solubility or an alcohol with at least 20% water solubility.

Clause 10. The pest control composition of clause 5, wherein the pest control composition comprises about 0.05 wt. % to about 0.1 wt. % pyrethrum, wherein a weight ratio of piperonyl butoxide to pyrethrum is about 5:1 to about 7:1, and wherein the at least one non-aqueous solvent is a propylene-based glycol ether.

Clause 11. The pest control composition of clause 5, wherein the pest control composition comprises about 0.08 wt. % pyrethrum, wherein a weight ratio of piperonyl butoxide to pyrethrum is about 6:1, and wherein the at least one non-aqueous solvent is a propylene-based glycol ether.

Clause 12. The pest control composition of clause 1, the pest control composition further comprising at least one propellant.

Clause 13. The pest control composition of clause 12, wherein the propellant is about 1 wt. % to about 15 wt. %, based on the total weight of the composition.

Clause 14. The pest control composition of clause 13, wherein the at least one propellant is nitrogen, liquified petroleum gas, butane, isobutane, propane, carbon dioxide, compressed air, or any combinations thereof.

Clause 15. The pest control composition of clause 14, wherein the pest control composition comprises about 0.1 to about 0.5 wt. % of pyrethrum and a weight ratio of piperonyl butoxide to pyrethrum is between about 1:1 and about 10:1.

Clause 16. The pest control composition of clause 14, wherein the pest control composition comprises between about 0.15 wt. % and about 0.3 wt. % pyrethrum and a weight ratio of piperonyl butoxide to pyrethrum is between about 9:1 and about 10:1.

Clause 17. The pest control composition of clause 16, wherein the pest control composition comprises between about 0.5 wt. % and 3 wt. % piperonyl butoxide, and the at least one non-aqueous solvent is a propylene-based glycol ether with at least 20% water solubility or an alcohol with at least 20% water solubility.

Clause 18. The pest control composition of clause 14, wherein the pest control composition comprises about 0.1 wt. % to about 0.5 wt. % pyrethrum, and about 1 wt. % to about 2.5 wt. % piperonyl butoxide, wherein a weight ratio of the piperonyl butoxide to pyrethrum is about 1:1 to about 10:1, and wherein the at least one non-aqueous solvent is a propylene-based glycol ether with at least 20% water solubility or an alcohol with at least 20% water solubility.

Clause 19. The pest control composition of clause 14, wherein the pest control composition comprises about 0.05 wt. % to about 0.1 wt. % pyrethrum, wherein a weight ratio of piperonyl butoxide to pyrethrum is between about 1:1 and about 10:1, and wherein the at least one non-aqueous solvent is a propylene-based glycol ether with at least 20% water solubility or an alcohol with at least 20% water solubility.

Clause 20. The pest control composition of clause 14, wherein the pest control composition comprises about 0.08 wt. % pyrethrum, wherein a weight ratio of piperonyl butoxide to pyrethrum is about 6:1, and the at least one non-aqueous solvent is a propylene-based glycol ether with at least 20% water solubility or an alcohol with at least 20% water solubility.

Clause 21. The pest control composition of any one of clauses 1-20, further comprising one or more of a corrosion inhibitor, a preservative, or a fragrance.

Clause 22. The pest control composition of clause 2, wherein the pest control composition comprises about 0.05 wt. % to about 0.5 wt. % of one or more pyrethroids and about 0.3 wt. % to about 2.0 wt. % of a synergist.

Clause 23. The pest control composition of any one of clauses 2-22, wherein the composition is clear.

Clause 24. The pest control composition of any one of clauses 1-5, wherein the pest control composition is colorless.

Clause 25. A method of killing insects including applying to a surface in need thereof a composition comprising: an active ingredient; at least one non-aqueous solvent; at least one surfactant; and water.

Clause 26. The method of clause 25, further comprising a synergist, wherein the active ingredient is about 0.05 wt. % to about 1 wt. % of pyrethrum, the synergist is about 0.45 wt. % to about 5 wt. % of piperonyl butoxide, the at least one non-aqueous solvent is about 2 wt. % to about 12 wt. %, the at least one surfactant is about 0.7 wt. % to about 8 wt. %, and the water is about 74 wt. % to about 91 wt. %, wherein a weight ratio of piperonyl butoxide to pyrethrum is between about 1:1 and about 20:1, and wherein all weight percentages are percent by weight of the total composition, and wherein the composition is in a single phase.

Clause 27. The method of clause 26, wherein the composition is clear.

Clause 28. A pest control composition, the composition comprising: at least one active ingredient, wherein the at least one active ingredient comprises pyrethrum in an amount of about 0.1-1.0 wt. %; at least one non-aqueous solvent present in an amount of about 1-12 wt. %; a first surfactant present in an amount of about 0.5-8.0 wt. %; a second surfactant present in an amount of about 0.5-6.0 wt. % and water.

Clause 29. The pest control composition of clause 28, further comprising a synergist in an amount of about 0.15 wt. % to about 4 wt. %.

Clause 30. The pest control composition of clause 29, wherein the pyrethrum is present in an amount of about 0.5 wt. %, wherein the at least one non-aqueous solvent is present in an amount of about 6 wt. %, wherein the first surfactant is present in an amount of about 2.5 wt. %, wherein the second surfactant is present in an amount of about 1.5 wt. %, wherein the synergist is present in an amount of about 1.05 wt. %, and wherein the water is present in an amount of about 88.25 wt. %.

Clause 31. The pest control composition of clause 28 or 29, wherein the synergist comprises piperonyl butoxide, wherein the first surfactant comprises an alcohol ethoxylate, wherein the second surfactant comprises a hydrogenated castor oil ethoxylate, and wherein the solvent comprises a propylene-based glycol ether.

### INDUSTRIAL APPLICABILITY

Numerous modifications to the present invention will be apparent to those skilled in the art in view of the foregoing description. Accordingly, this description is to be construed as illustrative only and is presented for the purpose of enabling those skilled in the art to make and use the invention. The exclusive rights to all modifications which come within the scope of the appended claims are reserved.

1. A pest control composition, the composition comprising:
at least one active ingredient;
at least one non-aqueous solvent;
at least one surfactant; and
water.

2. The pest control composition of claim 1, further comprising a synergist, wherein the active ingredient is about 0.05 wt. % to about 1 wt. % of pyrethroid, or pyrethrum, the synergist is about 0.10% wt. % to about 5 wt. % of piperonyl butoxide, or MGK-264, the at least one non-aqueous solvent is about 2 wt. % to about 12 wt. %, the at least one surfactant is about 0.7 wt. % to about 8.0 wt. %, and the water is about 74 wt. % to about 91 wt. %, and wherein a weight ratio of piperonyl butoxide or MGK-264 to pyrethrum is between about 1:1 and about 20:1, and wherein all weight percentages are percent by weight of the total composition, and wherein the composition is a single phase.

35. The pest control composition of claim 1, wherein the at least one non-aqueous solvent is a propylene-based glycol ether, acetone, an ester of citric acid, an alcohol with at least 20% water solubility, or any combination thereof.

4. (canceled)

5. The pest control composition of claim 2, wherein the at least one surfactant comprises about 1.1 wt. % to about 8.0 wt. % of a first surfactant and about 0.7 wt. % and to about 6.0 wt. % of a second surfactant, and wherein the at least one surfactant comprises hydrogenated castor oil, ethoxylated linear alcohol #9, polyethylene glycol sorbitan monooleate, polyethylene glycol stearate, sorbitan monooleate, a C6-C12 ethoxylated alcohol, sodium dodecyl benzenesulfonate, alcohol ethoxylate 4.0, ethoxylated linear alcohol, glyceryl monooleate, sorbitan monopalmitate, or any combinations thereof.

6. The pest control composition of claim 1, wherein the pest control composition is one or more of a single phase, clear, or colorless.

7. The pest control composition of claim 5, wherein the pest control composition comprises: i) about 0.05 wt. % to about 0.5 wt. % pyrethrum and a weight ratio of piperonyl butoxide to pyrethrum is between about 1:1 and about 10:1; or ii) one or more pyrethroids in an amount of about 0.05 wt. % to about 0.4 wt. % and a weight ratio of piperonyl butoxide to the one or more pyrethroids is about 0:1 to about 5:1.

8. The pest control composition of claim 5, wherein the pest control composition comprises about 0.5 wt. % to about 3 wt. % piperonyl butoxide, and the at least one non-aqueous solvent is a propylene-based glycol ether with at least 20% water solubility or an alcohol with at least 20% water solubility.

9. The pest control composition of claim 5, wherein the pest control composition comprises about 0.1 wt. % to about 0.5 wt. % pyrethrum, about 0.5 wt. % to about 3.0 wt. % piperonyl butoxide, wherein a weight ratio of piperonyl butoxide to pyrethrum is about 1:1 to about 10:1, and wherein the at least one non-aqueous solvent is a propylene-based glycol ether with at least 20% water solubility or an alcohol with at least 20% water solubility.

10. The pest control composition of claim 5, wherein the pest control composition comprises about 0.05 wt. % to about 0.1 wt. % pyrethrum, wherein a weight ratio of piperonyl butoxide to pyrethrum is about 5:1 to about 7:1, and wherein the at least one non-aqueous solvent is a propylene-based glycol ether.

11. (canceled)

12. The pest control composition of claim 1, the pest control composition further comprising at least one propellant, wherein the at least one Propellant comprises nitrogen, liquified petroleum gas, butane isobutane, propane, carbon dioxide, compressed air, or any combinations thereof, and wherein the propellant is about 1 wt. % to about 15 wt. %, based on the total weight of the composition.

13. (canceled)

14. (canceled)

15. The pest control composition of claim 12, wherein the pest control composition comprises about 0.1 to about 0.5 wt. % of pyrethrum and a weight ratio of piperonyl butoxide to pyrethrum is between about 1:1 and about 10:1.

16. The pest control composition of claim 12, wherein the pest control composition comprises between about 0.15 wt. % and about 0.3 wt. % pyrethrum and a weight ratio of piperonyl butoxide to pyrethrum is between about 9:1 and about 10:1, and wherein the pest control composition comprises between about 0.5 wt. % and 3 wt. % piperonyl butoxide, and the at least one non-aqueous solvent is a propylene-based glycol ether with at least 20% water solubility or an alcohol with at least 20% water solubility.

17. (canceled)

18. (canceled)

19. (canceled)

20. The pest control composition of claim 14, wherein the pest control composition comprises about 0.08 wt. % pyrethrum, wherein a weight ratio of piperonyl butoxide to pyrethrum is about 6:1, and the at least one non-aqueous solvent is a propylene-based glycol ether with at least 20% water solubility or an alcohol with at least 20% water solubility.

21. The pest control composition of claim 1, further comprising one or more of a corrosion inhibitor, a preservative, or a fragrance.

22. The pest control composition of claim 2, wherein the pest control composition comprises about 0.05 wt. % to about 0.5 wt % of one or more pyrethroids and about 0.3 wt. % to about 2.0 wt. % of a synergist.

23. (canceled)

24. (canceled)

25. A method of killing insects including applying to a surface in need thereof a composition comprising:
an active ingredient;
at least one non-aqueous solvent;
at least one surfactant; and
water.

26. The method of claim 25, further comprising a synergist, wherein the active ingredient is about 0.05 wt. % to about 1 wt. % of pyrethrum, the synergist is about 0.45 wt. % to about 5 wt. % of piperonyl butoxide, the at least one non-aqueous solvent is about 2 wt. % to about 12 wt. %, the at least one surfactant is about 0.7 wt. % to about 8 wt %, and the water is about 74 wt. % to about 91 wt. %, wherein a weight ratio of piperonyl butoxide to pyrethrum is between about 1:1 and about 20:1, and wherein all weight percentages are percent by weight of the total composition, and wherein the composition is in a single phase.

27. (canceled)

28. A pest control composition, the composition comprising:
at least one active ingredient, wherein the at least one active ingredient comprises pyrethrum in an amount of about 0.1-1.0 wt. %;
at least one non-aqueous solvent present in an amount of about 1-12 wt. %;
a first surfactant present in an amount of about 0.5-8.0 wt. %;
a second surfactant present in an amount of about 0.5-6.0 wt. % and water.

29. The pest control composition of claim 28, further comprising a synergist in an amount of about 0.15 wt. % to about 4 wt. % and wherein the synergist comprises piperonyl butoxide, wherein the first surfactant comprises an alcohol ethoxylate, wherein the second surfactant comprises a hydrogenated castor oil ethoxylate, and wherein the solvent comprises a propylene-based glycol ether.

30. The pest control composition of claim 29, wherein the pyrethrum is present in an amount of about 0.5 wt. %, wherein the at least one non-aqueous solvent is present in an amount of about 6 wt. %, wherein the first surfactant is present in an amount of about 2.5 wt. %, wherein the second surfactant is present in an amount of about 1.5 wt. % wherein the synergist is present in an amount of about 1.05 wt. %, and wherein the water is present in an amount of about 88.25 wt. %.

31. (canceled)
